(19) United States
(12) Patent Application Publication
(10) Pub. No.: US 2011/0113161 A1
(43) Pub. Date: May 12, 2011

(54) OPTICAL DISK CONTROL DEVICE

(76) Inventors: Yasutsugu Toyoda, Kyoto (JP); Naoyuki Takezaki, Osaka (JP)

(21) Appl. No.: 12/812,275

(22) PCT Filed: Jan. 9, 2009
(86) PCT No.: PCT/JP2009/000069

§ 371 Date: Jul. 9, 2010

(30) Foreign Application Priority Data
Jan. 11, 2008 (JP) 2008-004199

(51) Int. Cl. G06F 3/00

(52) U.S. Cl. 710/10

(57) ABSTRACT

At determining the data transfer scheme of an optical disk control device, the data transfer scheme is stored in the data transfer scheme storing unit, whether it is a resetting by a reset pulse or not is judged at the reset starting, and when it is a reset caused by a reset pulse, the data transfer scheme stored is used to start and perform data communication. Thereby, even when a resetting is performed by external factors such as static-electricity, the hung-up with the host PC can be avoided, and further, power saving and high multiple speed can be realized.

### TECHNICAL FIELD

The present invention particularly relates to an optical disk control device which is provided with a transfer mode control means for setting a transfer mode.

### BACKGROUND ART

There are three kinds of data transmission schemes between a host personal computer and an optical disk control device. A PIO (Programmed I/O) scheme performs a transfer control via a register which can perform an access to both of the host computer and the optical disk control device at a transfer rate of 8.33 MB/s at maximum. The DMA is a scheme that can perform a transfer of a bus master scheme, and has realized a transfer rate of 16.7 MB/s since the CPU of the host PC is released from a polling operation, a transfer rate of 16.7 MB/s is realized. An ultra DMA is a scheme that performs a data transfer at both of rise and fall of clocks, and this has improved the transfer rate to 100 MB/s from 33.3 MB/s, resulting in a high speed transfer.

The data transfer scheme between the host personal computer (host PC) and an optical disc control device is determined by that a PIO transfer scheme is firstly selected, and the host PC issues a transfer mode setting command utilizing a register to the optical disc control device, thereby to select a data transfer scheme by which the transfer rate at maximum among those which are supported by the optical disc control device.

The data transfer scheme is required to be synchronized between the host PC and the optical disc control device, and if these do not coincide with each other, there arises a mismatch in the control of data transfer, thereby occurring a hung-up in the data communication.

By the way, there are three kinds of resets in an optical disc control device, i.e., a hardware reset which performs an initialization by issuing a reset pulse at a reset terminal, a software reset which performs an initialization by using a register, and a device reset which performs an initialization using a command.

Since a host personal computer (an operating system operating on that PC, hereinafter referred to as “OS”) usually issues a reset with consciousness, the personal computer issues a command synchronizing the data transfer scheme after the resetting so as to make those coincide with each other, and thereby the data communication would not be hung-up.

FIG. 11 is a block diagram illustrating a prior art optical disc control device.

In FIG. 11, reference numeral 1111 designates a host personal computer which controls the optical disc control device to read out data.

Numeral 1104 designates a CPU for controlling the optical disc control device.

Numeral 1105 designates an initialization control unit which issues an initialization request signal to the CPU 1104 when a reset pulse is issued from the host personal computer 1111.

In addition, numeral 1101 designates a control program storing unit in which an optical disc control program is stored.

Numeral 1106 designates a communication control unit which controls issuance of an optical disk control device control command and exchanges of information such as the transfer enabling state, the transfer state, and presence or non-presence of error occurrence with the host personal computer 1111.

Numeral 1102 designates a data transfer scheme setting unit for storing the data transfer scheme.

Numeral 1102 designates a data transfer scheme setting unit which has stored the data transfer scheme.

Numeral 1108 designates a data transfer control unit which receives the data transfer request from the host personal computer 1111 and controls the data transfer according to the transfer mode which is set in the data transfer scheme setting unit 1102, and this is operated to store data in the data temporary storing unit 1109 via a bus.

Numeral 1107 designates an interruption processing unit which issues an interrupt signal to the CPU 1104 when reception of a data transfer control request signal or a communication control request were generated.

Numeral 1103 designates a command analysis block which analyzes the content of the optical disk control device control command to execute it.

FIGS. 12(a) to 12(b) are flowcharts illustrating the operation of a prior art optical disk control device.

In FIG. 12(a), by the external factors such as static-electricity, a reset sequence is started, and an initial starting is performed (step S1202).

As shown in FIG. 12(b), after the host personal computer 1111 at the transmitter side is powered on, the host personal computer 1111 issues a reset pulse (data initialization signal) to the initialization control unit 1105 of the optical disc control device at the receiver side from the reset terminal 1110 (step S1204).

The initialization control unit 1105 issues, after receiving the reset pulse (Yes at step 1205), a reset signal to the CPU 1104.

Next, the optical disc control device at the receiver side performs an initial setting at the same transfer mode as the host PC 1111 at the transmitter side (step S1206).

Hereinafter, a description is given in detail. After a reset request being issued, the CPU 1104 executes an optical disc control program which is stored in the control program storing unit 1101.

At initial starting, the CPU 1104 stores, after performing respective initialization processing, the PIO mode as a default value of a data transfer scheme in the data transfer scheme setting unit 1102. In addition, it performs a setting for making the communication control unit 1106 in an executable state for a command from the host personal computer 1111.

After performing a setting making the communication control unit 1106 in an executable state for a command from the host PC 1111, the CPU 1104 controls the interrupt processing unit 1107 to issue an interrupt signal to the host personal computer 1111.

The host personal computer 1111 judges, by an interruption, that the optical disk control device is in a receivable state for a command, and requests the maximum data transfer scheme that is supported by the optical disc control device. The host personal computer 1111 sets at the communication control unit 1106 a request command requesting the transfer mode supported by the optical disc control device. When a command is set at the communication control unit 1106, the host personal computer 1111 controls the interrupt processing unit 1107 to issue an interrupt signal to the CPU 1104. The CPU 1104 which received the interrupt signal analyzes the command which is set in the communication control unit 1106 by the command analyzing unit 1103, and judges it as a command transmitting the supported transfer mode. The CPU 1104 reads out the supported transfer mode data from the control program storing unit 101, and stores same in the data temporary storing unit 1109.

The CPU 1104 controls the data transfer control unit 1108 to transmit the supported transfer mode data stored in the data transfer control unit 1109. After completing the data transmission, the data transfer control unit 1108 controls the interrupt processing unit 1107 to issue an interrupt signal (completion code) informing conclusion of the data transfer to the CPU 1104 (step S1207).

The host PC 1111 sets a request command for requesting a support transfer mode of an optical disk control device in the communication control unit 1106. When a command is set in the communication control unit 1106, the host PC 1111 controls the interruption processing unit 1107, and issues an interruption signal to the CPU 1104. The CPU 1104 which has received the interruption signal analyzes the command set in the communication control unit 1106 by the command analyzing unit 1103, and judges it as a command transmitting the support transfer mode. The CPU 1104 reads out the support transfer mode data from the control program storing unit 1101, to store it in the data temporary storing unit 1109.

The CPU 1104 controls the data transfer control unit 1108 to transmit the support transfer mode data in the data temporary storing unit 1109. After completing the data transmission, the data transfer control unit 1108 controls the interruption processing unit 1107 to issue an interruption signal (completion code) informing the completion of the data transfer (step S1207). The CPU 1104 performs, after receiving the interrupt signal(Yes at step S1208), a setting, at the communication control unit 1106, that makes the communication control unit 1106 executable to perform a command.

After setting the communication control unit 1106 at a state that is executable to perform a command from the host personal computer 1111, the CPU 1104 controls the interrupt processing unit 1107 to issue an interruption signal to the host personal computer 1111.

The host PC 1111 requests a data transfer scheme which can provide the maximum transfer rate of the optical disk control device from the support transfer mode data.

The host personal computer 1111 issues a transfer mode setting command at the communication control unit 1106 (step S1209). In addition, the host personal compute 1111 sends out the transfer mode setting data to the communication control unit 1106 (step S1210). When the command is set at the communication control unit 1106, the host personal computer 1111 controls the interruption processing unit 1107 to issue an interruption signal to the CPU 1104. The CPU 1104 which has received the interruption signal analyzes the command which is set in the communication control unit 1106 by the command analyzing unit 1103, and judges it as a command setting the transfer mode. The CPU 1104 sets the transfer mode requested at the data transfer scheme setting unit (step S1211). A report of completion is performed from the optical disk control device at the receiver side to the host personal computer 1111 at the transmitter side (step S1212).

Thereafter, the data communication is processed by the set data transfer scheme (step S1213), and then a system operation processing is performed (step S1203).

In this way, in the flowchart of the prior art optical disk control device shown in FIG. 12, the host personal computer 1111 issues, after powering up, a reset pulse from a reset terminal, and also issues a transfer mode setting command. However, if static-electricity or the like is generated, a noise pulse is imposed on the reset terminal, and the initialization control unit 1105 of the optical disk control device misjudges it as a reset pulse, a hardware resetting occurs, but in that case, the host personal compute 1111 cannot judge as the optical disk control device being reset, and does not issue a transfer mode setting command for making the data transfer scheme coincide. Since the optical disk control device is reset, the data transfer scheme is in the PIO as a default, and thereby the transfer mode is not in coincidence with the host PC 1111, and the data communication is hung up.

A representative example which solves this problem, there is Japanese published patent publication No. Hei. 5-244216.

In the patent scope of Japanese published patent publication No. Hei. 5-244216, there is described that when the data communication is in a hung-up state, an initialization signal is sent out from the host personal computer (at transmitter side) to the optical disk control device (at receiver side) to initialize the data transfer schemes both at transmitter side and at receiver side to make those coincide with each other, to send out the transfer mode setting command and subsequently the transfer mode setting data from the transmitter side, to decode those data at the receiver side to set the data transfer scheme, and then to restore the data communication from the hung-up state.

FIG. 13 is a block diagram illustrating a construction of a device which performs setting of a transfer mode as described in Japanese published patent publication No. Hei. 5-244216. In FIG. 13, reference numerals 1301 to 1304 and 1306 to 1310 are the same as 1101 to 1111 in FIG. 1.

As compared with the prior art optical disk control device shown in FIG. 11, a communication state observing unit 1311 for observing whether the communication is hung-up or not, an initialization signal issuance unit 1313 for transmitting a communication restoring signal to the optical disk control device, and a communication restoring unit 1312 for performing a communication restoring processing are added to the host personal computer 1315, while an initialization signal receiving unit 1305 for receiving the initialization signal and synchronizing the data transfer scheme with that provided by the host personal computer 1315 is added to the optical disk control device.

When the data communication is hung-up, the communication state observing unit 1311 of the host personal computer 1315 judges it as being hung-up, and confirms the current data communication scheme of the host personal computer PC 1315.

FIG. 14(a) to 14(b) are flowcharts illustrating the operation of the device performing a transfer mode setting as disclosed in Japanese published patent publication No. Hei. 5-244216.

In FIG. 14(a), by the external factors such as static-electricity (step S1414), a reset sequence is started (step S1401), and an initialization starting is performed (step S1402).

As shown in FIG. 14(b), the communication state observing unit 1311 of the host personal computer 1315 at the transmitter side sets the transfer mode at the initialization signal issuance unit 1313, and issues an initialization signal to the optical disk control device at the receiver side (step S1404). When the initialization signal receiving unit 1305 of the optical disk control device receives the initialization signal (Yes at step S1405), it sets, at initially setting the optical disk control device at the receiver side at the same transfer mode as the host personal computer at the transmitter side, the data transfer scheme in the data transfer scheme setting unit 1302 (step S1406), and then, transmits a completion signal (completion code) to the initialization signal issuance unit 1313 (step S1407), thereby informing it being at a data receivable state to the host personal computer 1315 (Yes at step S1408).

The host PC 1315 at the transmitter side sends out a transfer mode setting command to the communication control unit 1307 (step S1409), and sends out the transfer mode setting date of 1 byte (step S1410). The optical disk control device at the receiver side sets the transfer mode from the transfer mode setting data (step S1411), and the optical disk control device at the receiver side sends a response indicating it being in a receivable state to the host personal computer 1315 at the transmitter side (step S1412), thereby controlling the data transfer control unit 1309 to restart the data transfer (step S1413).

Patent Document 1: Japanese published patent publication No. Hei. 5-244216.

### DISCLOSURE OF THE INVENTION

### Problems to be Solved by the Invention

In the control method disclosed in Japanese published patent publication No. Hei. 5-244216, it is required that the host personal computer performs a polling of hung-up or judgment thereof, thereby resulting in an increased load to the host PC.

In addition, both of the host personal computer and the optical disk control device require special mechanisms for performing a communication restart processing, and without these special mechanism, the host personal computer perform a communication restarting. In addition, since the bus for data transfer is occupied during the communication being hung-up, it is required to provide a bus for communication separately.

Further, the control time for the hung-up judgment, transmission and reception of the initialization signal, and recovery transmission and reception would have been increased.

Therefore, there is a possibility that there occur influences on the disc access at a high multiple speed. In addition, the amount of power used would have increased.

The present invention is directed to solving the above-described problems and has for its object to provide an optical disk control device that can avoid the hung-up of the data communication with the host personal computer even when a reset is triggered by external factors such as static-electricity, thereby enabling to accommodate electrical power saving and a high multiple speed.

### Measures to Solve the Problems

In order to solve the above-described problems, according to claim 1 of the present invention, there is provided an optical disk control device, comprising: a CPU for controlling an optical disk control device, connected to a host PC; an initialization control unit for outputting an initialization request signal to the CPU when a reset pulse is issued from the CPU; a control program storing unit for storing an optical disc control program; a communication control unit for controlling issuance of a control command for controlling an optical disk control device and communication of information indicating a transfer enable state, a transfer state, and presence or non-presence of error generation with the host PC; a data transfer scheme setting unit for storing a data transfer scheme; a data transfer scheme storing unit for storing the data transfer scheme when the data transfer scheme is set from the host PC; a data transfer control unit for receiving the data transfer request from the host PC and controlling the data transfer according to the transfer mode which is set at the data transfer scheme setting unit; a data temporary storing unit for storing data via a bus; an interruption processing unit for issuing an interruption signal to the CPU when reception of the data transfer control request reception and a communication control request are generated; a command analyzing unit for analyzing the content of the optical disk control device control command and executing same; and a reset judging unit for judging whether an initialization request signal is due to noises or a request from the host PC on the basis of the presence or non-presence of the transfer mode setting from the host PC at an initialization starting and judges whether the data transfer scheme is to be read out from the data transfer scheme storing unit to be set.

According to claim 2 of the present invention, there is provided an apparatus which comprises an optical disk control device as defined in claim 1, comprising a transfer scheme decision delaying unit which generates a time delay that is larger than a pulse generation interval before determining the data transfer scheme. Thereby, it is possible to perform a data communication that is further stable even when reset pulses are generated in plurality.

According to claim 3 of the present invention, there is provided an optical disk control device as defined in claim 1, wherein the reset judging unit further performs a cancellation of the transfer scheme, and a transfer scheme cancellation delaying unit which outputs a transfer scheme cancellation signal to the reset judging unit after a tray is closed. Thereby, it is possible to perform a data communication that is further stable even when reset pulses are generated in plurality.

According to claim 4 of the present invention, there is provided an optical disk control device as defined in claim 1, wherein there is provided a flash storing region searching unit which, before performing flash erasing, searches vacant regions of other sectors to change the flash region to be used by the data transfer scheme storing unit, stores the sector numbers which have been used, and cancels, when there is no vacant sectors, the sector numbers which are stored to secure regions. Thereby, an optical disk control device which can extend the life of the memory region such as a flash ROM and thus can be used for a long period of time is provided.

According to claim 5 of the present invention, there is provided an optical disk control device as defined in claim 1, wherein the data transfer scheme storing unit is provided with a drive selection unit which further stores the drive information indicating a master or a slave, and determines whether the optical disk control device is a master or a slave. Thereby, the optical disc starting time is reduced as well as the load to the CPU is suppressed, and thereby an electrical power saving and a high multiple speed data communication are enabled.

### Effects of the Invention

According to the present invention, in an optical disk control device which performs a data transfer with a host PC, even when resetting is triggered by external disturbances such as static-electricity, the host PC is not subjected to a large load, thereby a stable data transmission and power saving can be realized and a high multiple speed recording can be comprised. The optical disk control device of the present invention is particularly effective during use under a notebook PC environment where external disturbances by such as static-electricity may occur frequently.

### BRIEF DESCRIPTION OF THE DRAWINGS

FIG. 1 is a block diagram illustrating a construction of an optical disk control device according to a first embodiment of the present invention.

FIG. 2(a) is a flowchart illustrating an operation of an optical disk control device according to the first embodiment of the present invention.

FIG. 2(b) is a flowchart illustrating an operation of an optical disk control device according to the first embodiment of the present invention.

FIG. 2(c) is a flowchart illustrating an operation of an optical disk control device according to the first embodiment of the present invention.

FIG. 3 is a block diagram illustrating a construction of an optical disk control device according to a second embodiment of the present invention.

FIG. 4(a) is a flowchart illustrating an operation of an optical disk control device according to the second embodiment of the present invention.

FIG. 4(b) is a flowchart illustrating an operation of an optical disk control device according to the second embodiment of the present invention.

FIG. 4(c) is a flowchart illustrating an operation of an optical disk control device according to the second embodiment of the present invention.

FIG. 5 is a block diagram illustrating a construction of an optical disk control device according to a third embodiment of the present invention.

FIG. 6(a) is a flowchart illustrating an operation of an optical disk control device according to the third embodiment of the present invention.

FIG. 6(b) is a flowchart illustrating an operation of an optical disk control device according to the third embodiment of the present invention.

FIG. 6(c) is a flowchart illustrating an operation of an optical disk control device according to the third embodiment of the present invention.

FIG. 7 is a block diagram illustrating a construction of an optical disk control device according to a fourth embodiment of the present invention.

FIG. 8(a) is a flowchart illustrating an operation of an optical disk control device according to the fourth embodiment of the present invention.

FIG. 8(b) is a flowchart illustrating an operation of an optical disk control device according to the fourth embodiment of the present invention.

FIG. 8(c) is a flowchart illustrating an operation of an optical disk control device according to the fourth embodiment of the present invention.

FIG. 9 is a block diagram illustrating a construction of an optical disk control device according to a fifth embodiment of the present invention.

FIG. 10(a) is a flowchart illustrating an operation of an optical disk control device according to the fifth embodiment of the present invention.

FIG. 10(b) is a flowchart illustrating an operation of an optical disk control device according to the fifth embodiment of the present invention.

FIG. 10(c) is a flowchart illustrating an operation of an optical disk control device according to the fifth embodiment of the present invention.

FIG. 11 is a block diagram illustrating a construction of a prior art optical disk control device.

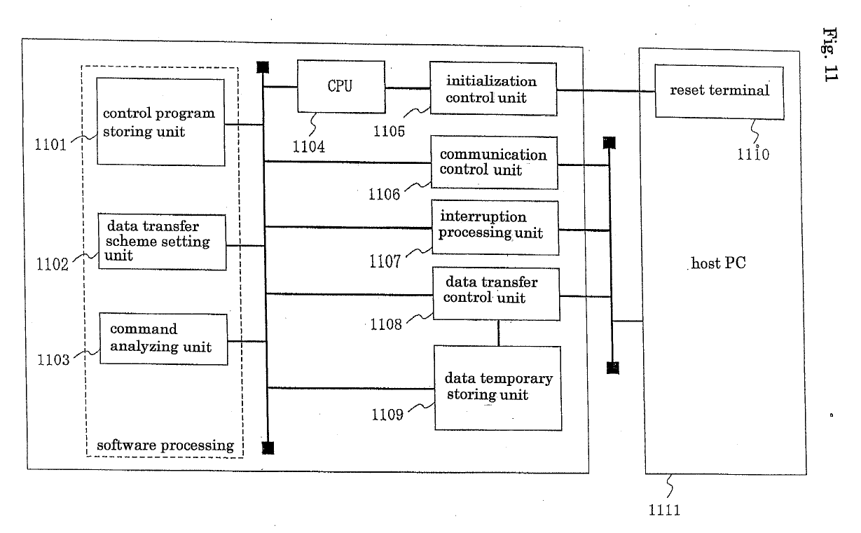

FIG. 12(a) is a flowchart illustrating an operation of the prior art optical disk control device.

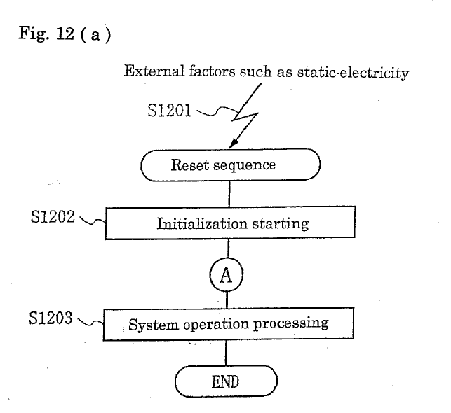

FIG. 12(b) is a flowchart illustrating an operation of the prior art optical disk control device.

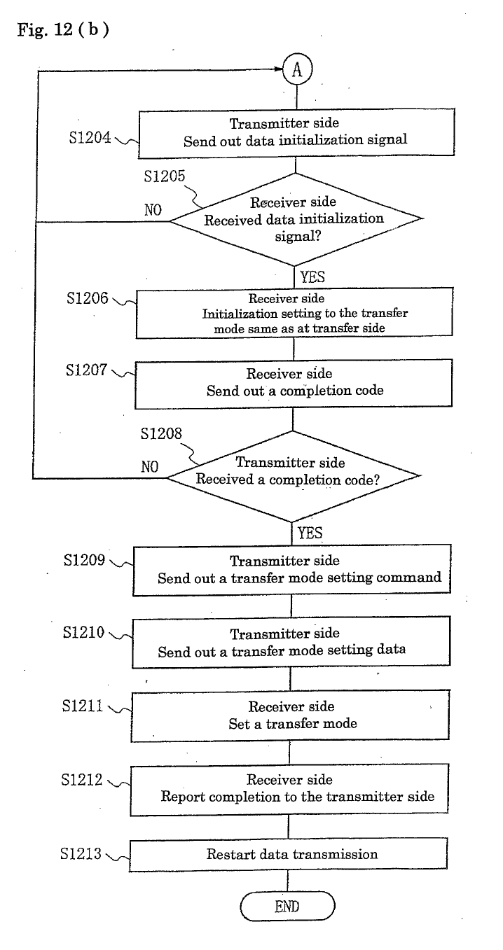

FIG. 13 is a block diagram illustrating a construction of the device disclosed in Japanese published patent application No. Hei. 5-244216.

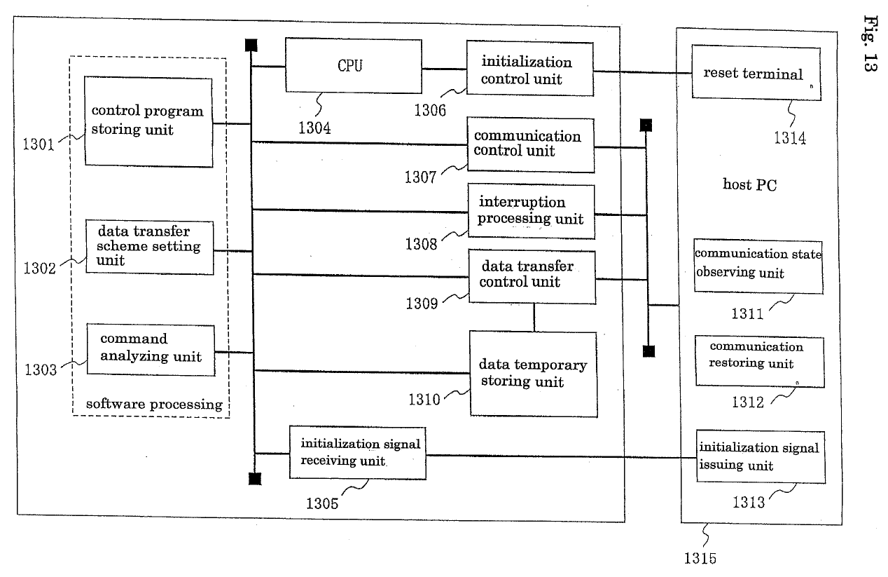

FIG. 14(a) is a flowchart illustrating an operation of the device of Japanese published patent application No. Hei. 5-244216.

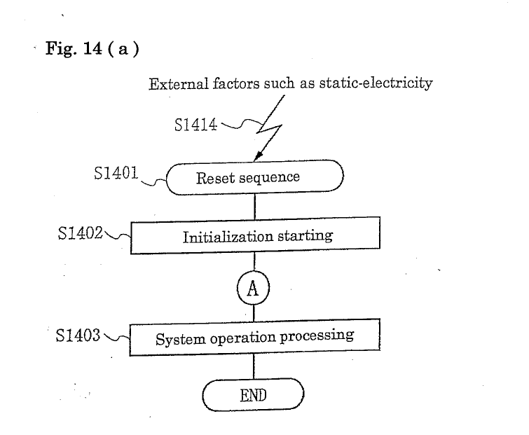

FIG. 14(b) is a flowchart illustrating an operation of the device of Japanese published patent application No. Hei. 5-244216.

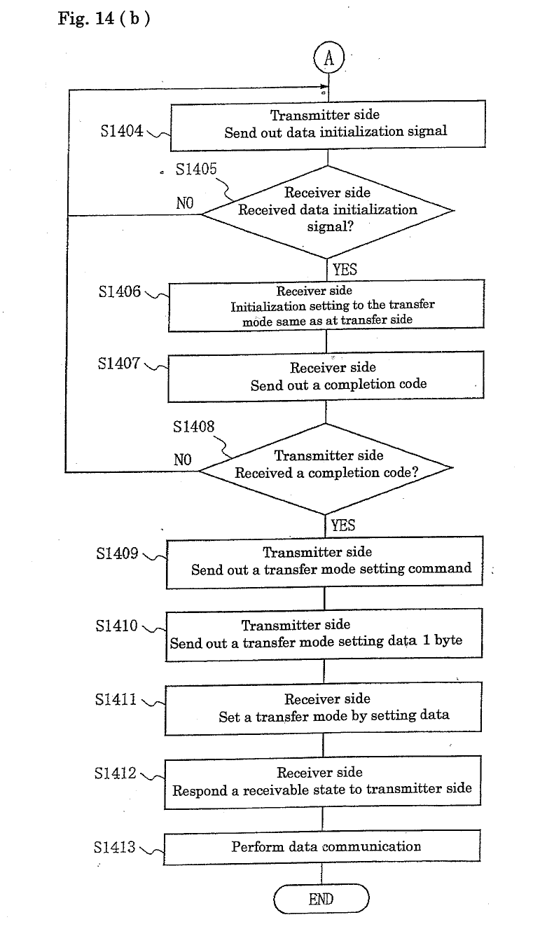

FIG. 15 shows a judgment processing that is performed at the initialization.

### DESCRIPTION OF REFERENCE NUMERALS

101 control program storing unit

102 data transfer scheme setting unit

103 data transfer scheme storing unit

104 command analyzing unit

105 reset judgment unit

106 CPU

107 initialization control unit

108 communication control unit

109 interruption processing unit

110 data transfer control unit

111 data temporary storing unit

112 reset terminal

113 host PC

301 control program storing unit

302 data transfer scheme setting unit

303 data transfer scheme storing unit

304 command analyzing unit

305 reset judging unit

306 CPU

307 transfer scheme determination time delaying unit

308 initialization control unit

309 communication control unit

310 interruption processing unit

311 data transfer control unit

312 data temporary storing unit

313 reset terminal

314 host PC

501 control program storing unit

502 data transfer scheme setting unit

503 data transfer scheme storing unit

504 command analyzing unit

505 reset judging and transfer scheme cancellation execution unit

506 CPU

507 transfer scheme cancellation delaying unit

508 initialization control unit

509 communication control unit

510 interruption processing unit

511 data transfer control unit

512 data temporary storing unit

513 reset terminal

514 host PC

701 control program storing unit

702 data transfer scheme setting unit

703 data transfer scheme storing unit

704 command analyzing unit

705 reset judging unit

706 CPU

707 flash region searching unit

708 initialization control unit

709 communication control unit

710 interruption processing unit

711 data transfer control unit

712 data temporary storing unit

713 reset terminal

714 host PC

901 control program storing unit

902 data transfer scheme setting unit

903 data transfer scheme drive information storing unit

904 command analyzing unit

905 reset judging unit

906 CPU

907 initialization control unit

908 communication control unit

909 interruption processing unit

910 drive selection unit

911 data transfer control unit

912 data temporary storing unit

913 reset terminal

914 host PC

1101 control program storing unit

1102 data transfer scheme setting unit

1103 command analyzing unit

1104 CPU

1105 initialization control unit

1106 communication control unit

1107 interruption processing unit

1108 data transfer control unit

1109 data temporary storing unit

1110 reset terminal

1111 host PC

1301 control program storing unit

1302 data transfer scheme setting unit

1303 command analyzing unit

1304 CPU

1305 initialization signal receiving unit

1306 initialization control unit

1308 interruption processing unit

1309 data transfer control unit

1310 data temporary storing unit

1311 communication state observing unit

1312 communication restoring unit

1313 initialization signal issuing unit

1314 reset terminal

1315 host PC

### BEST MODE TO EXECUTE THE INVENTION

Hereinafter, embodiments of the present invention will be described with reference to the drawings.

### Embodiment 1

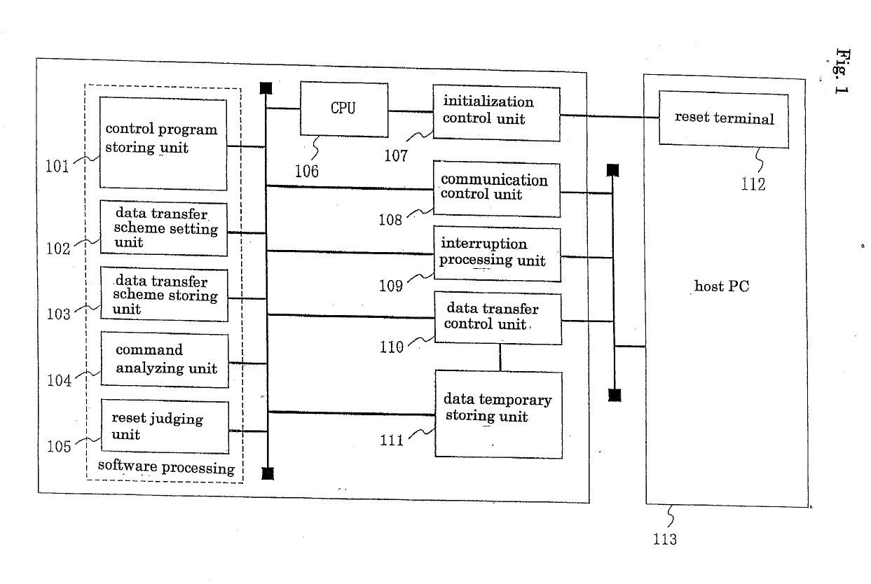

FIG. 1 is a block diagram illustrating a construction of an optical disk control device according to a first embodiment of the present invention. The optical disk control device of this first embodiment corresponds to the invention recited in claim 1.

In FIG. 1, reference numeral 113 denotes a host PC which controls the optical disk control device to read out data.

Numeral 106 denotes a CPU which controls the optical disk control device.

Numeral 107 denotes an initialization control unit which issues an initialization request signal (reset signal) to the CPU 106 when a reset pulse is issued from the host PC 113.

In addition, numeral 101 denotes a control program storing unit in which an optical disc control storing program is stored.

Numeral 108 denotes a communication control unit which controls issuance of an optical disk control device control command and interchanges of information relating to the transfer enable state, the transfer state, and presence or non-presence of error occurrence with the host PC 113.

Numeral 102 denotes a data transfer scheme setting unit which stores data transfer schemes.

Numeral 103 denotes a data transfer scheme storing unit which stores the data transfer scheme when a data transfer scheme is set from the host PV 113.

Numeral 110 denotes a data transfer control unit which receives the data transfer request from the host PC 113, and controls the data transfer according to the transfer mode which is set in the data transfer scheme setting unit 102, thereby storing the data in the data temporary storing unit ill via a bus.

Numeral 109 denotes an interruption processing unit which issues an interrupt signal to the CPU 106 when reception of the data transfer control request signal reception or a communication control request signal are generated.

Numeral 104 denotes a command analyzing unit which analyzes the content of the optical disk control device control command to execute it.

Numeral 105 denotes a reset judgment unit which judges as to whether the initialization request signal is due to noises or a request from the host PC 113 from the presence or non-presence of the transfer mode setting from the host PC 113 at the initialization starting, and further judges whether the data transfer scheme is to be read out from the data transfer scheme storing unit 103 to be set.

The control program storing unit 101, the data transfer scheme setting unit 102, the data transfer scheme storing unit 103, the command analyzing unit 104, and the reset judgment unit 105 are usually processed by a software which is stored in a memory such as a readable and writable flash ROM.

The operation of the optical disk control device according to the first embodiment of the present invention will be described.

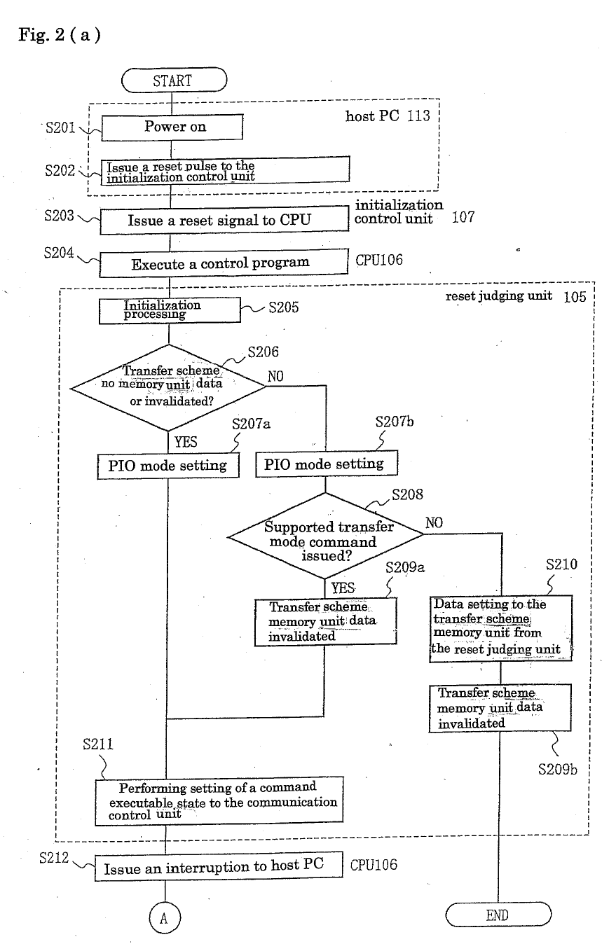

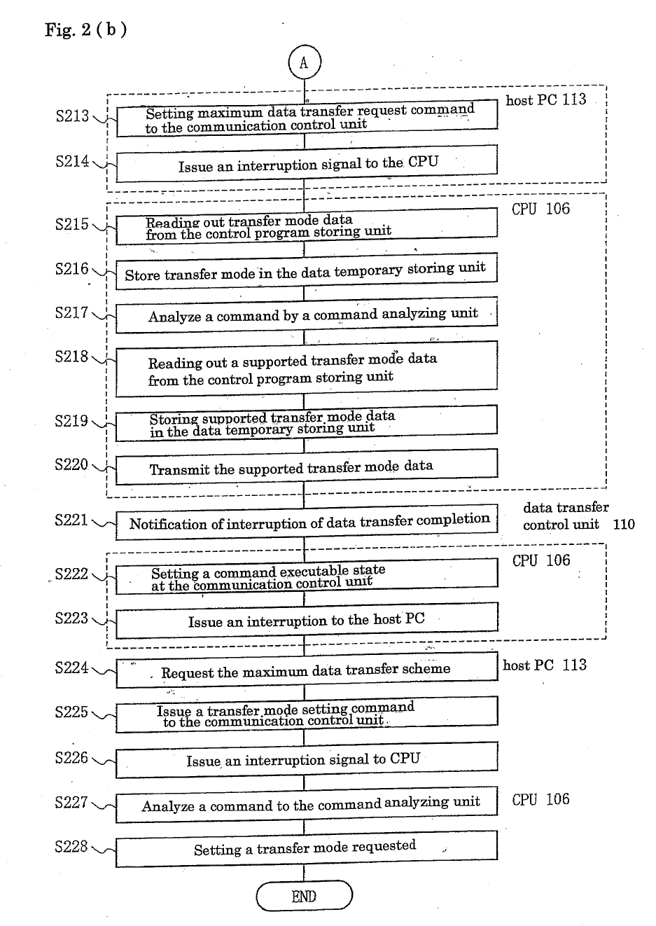

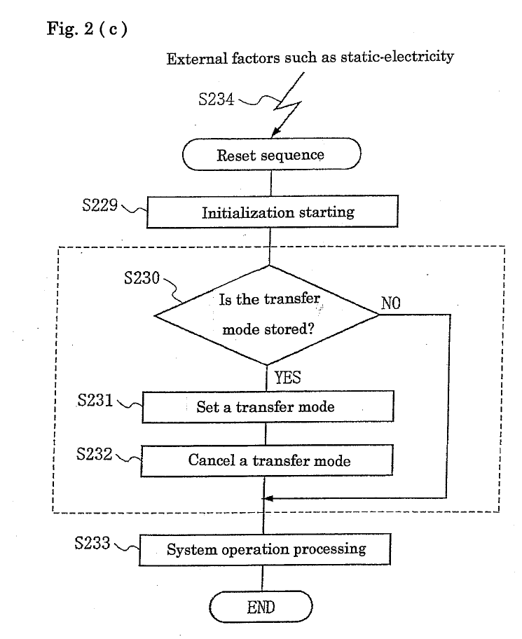

FIG. 2(a) to 2(c) are flowcharts illustrating operations of an optical disk control device according to the first embodiment of the present invention.

First of all, the operation of the host PC after the powering-up will be described.

In FIG. 2(a), after the host PC 113 is powered-up (step S201), the host PC 113 issues a reset pulse to the initialization control unit 107 of the optical disk control device from the reset terminal 112 (step S202).

The initialization control unit 107 issues, after having received the reset pulse, a reset signal to the CPU 106 (step S203).

After performing the reset request, the CPU 106 executes an optical disc control program stored in the control program storing unit 101 (step S204).

The reset judging unit 105 performs respective initialization processing at initialization starting (step S205), and confirms that no data is present or invalidated data is set in the data transfer scheme storing unit 103 (step S206).

Here, since when the power is turned on, no data is present or invalidated data is set in the data transfer scheme storing unit 103 (Yes at step S206), a PIO mode as a default value of the data transfer scheme is stored in the data transfer scheme setting unit 102 (step S207a). Thereby, the initial transfer mode after the powering-on is determined to be PIO mode.

When an effective transfer mode is stored in the data transfer scheme storing unit 103 (No at step S206), the reset judgment unit 105 once stores the PIO as a default value in the data transfer scheme setting unit 102 (step S207b). Then, it confirms the next command from the host PC 113 (step S208). When a command requesting the supported transfer mode is issued from the host PC 113 (Yes at step S208), it is judged by the reset judging unit 105 that it is a powering-up and the reset pulse is a request from the host PC 113, and the reset judging unit 105 invalidates the data in the data transfer scheme storing unit 103 with maintaining the default value setting as it is (step S209a). Then, in step S209a, the transfer mode in the past in the data transfer scheme storing unit 103 is cancelled, and the transfer mode designated by the command is stored. Thereby, the transfer mode is determined to the transfer mode designated by the command from the host PC 113.

Next, when the data transfer scheme is determined at the PIO data in step S207a, or at the transfer mode designated by the command from the host PC 113 in step S209a, a setting making the communication control unit 108 at an executable state for a command from the host PC 113 is performed (step S211). After the setting of the communication control unit 108 in an executable state for the command from the host PC 113 is performed, the CPU 106 controls the interruption processing unit 109 to issue an interrupt signal to the host PC 113 (step S212).

The host PC 113 judges, by an interruption, that the optical disk control device is in an executable state for a command and requests the maximum data transfer scheme which is supported by the optical disk control device. As shown in FIG. 2(b), the host PC 113 sets a request command for requesting a transfer mode supported by the optical disk control device to the communication control unit 108 (step S213f). If a command is set at the communication control device 108, the host PC 113 controls the interruption processing unit 109 to issue an interruption signal to the CPU 106 (step S214). The CPU 106 reads out the transfer mode data from the control program storing unit 101 (step S215) and stores the data in the data temporary storing unit 111 (step S216).

In addition, the CPU 106 which received the interruption signal analyzes the command which is set in the communication control unit 108 by the command analyzing unit 104 (step S217) and judges the supported transfer mode data as a command to be transmitted. The CPU 106 reads out the supported transfer mode data from the control program storing unit 101 (step S218) and stores the supported transfer mode data in the data temporary storing unit 111 (step S219).

The CPU 106 controls the data transfer scheme setting unit 102 to send the supported transfer mode data in the data temporary storing unit 111 to the host CPU 113 (step S220). After completing the data transmission, the data transfer control unit 110 controls the interruption processing unit 109 to issue an interruption signal informing the completion of data transfer to the CPU 106 (step S221). The CPU 106 performs, after receiving the interruption signal, a setting making the communication control unit 108 in an executable state for a command from the host PC 113 (step S222).

After setting the communication control unit 108 in an executable state for a command from the host PC 113 (step S222), the CPU 106 controls the interruption processing unit 109 to issue an interruption signal to the host PC 113 (step S223).

The host PC 113 requests a data transfer scheme by which the maximum transfer rate of the optical disk control device can be expected among the supported transfer mode data (step S224).

The host PC 113 issues a transfer mode setting command to the communication control unit 108 (step S225). When a command is set at the communication control unit 108, the host PC 113 controls the interruption processing unit 109 to issue an interrupt signal to the CPU 106 (step S226). The CPU 106 which received the interruption signal analyzes the command which is set in the communication control unit 108 by the command analyzing unit 104 (step S227) and judges is as a command setting a transfer mode. The CPU 106 sets the requested transfer mode in the transfer scheme setting unit 102 (step S228). In this way, a setting of a transfer mode according to a normal operation is performed after completing the powering-up.

The reset judging unit 105 stores, when the above-described transfer mode setting command is issued, the transfer mode which is set in the data transfer scheme setting unit 102 in the data transfer scheme storing unit 103.

Subsequently, the data communication is controlled by the set transfer mode.

Next, an operation when a resetting is triggered by noises will be described. When the reset pulses are noises, an operation from step S203 to step 209b as shown in FIG. 2(a) is performed.

When the reset pulses inputted to the initialization control unit 107 are noises, no command requesting the supported transfer mode is issued. Therefore, when no command requesting the supported transfer mode is issued from the host PC 113(No at step S208), it is judged by the reset judging unit 105 that the reset pulse comes from noises, and the rest judging unit 105 sets the transfer mode by which it is operated before the resetting is received (step S210) as a transfer mode, and stores the transfer mode which is stored in the data transfer scheme storing unit 103 in the data transfer scheme setting unit 102. In addition, the reset judging unit 105 invalidates the data which is stored in the data transfer scheme storing unit 103 (step S209b), and sets the invalidated data in the data transfer scheme storing unit 103. Here, in order to start driving as soon as possible at the powering-up, setting of the invalidated data in the data transfer scheme string unit 103 is performed.

In this way, when the rest pulse is due to noises, the data communication is controlled by the transfer mode which is set in the data transfer scheme setting unit 102, i.e., the transfer mode which is stored in the data transfer scheme storing unit 103.

Besides, the reset judging unit 105 cancels, when regions in the data transfer scheme storing unit 103 are gone thereby to unable data storage, regions in the data transfer scheme storing unit 103 to secure regions.

Here, when the reset terminal picks up noises due to such as static-electricity and thereby the initialization control unit 107 erroneously judges a reset request, though the CPU 106 performs an initialization starting processing, the data transfer scheme is synchronized with the host PC 113, thereby occurring no hung-up.

For example, when there are, as shown in FIG. 2(c), external factors such as static-electricity (step S234), a reset sequence is started, and an initialization starting is performed by the CPU 106 (step S229). When the transfer mode before receiving resetting is stored in the data transfer scheme storing unit 103 (Yes at step S230), the reset judging unit 105 sets the transfer mode which is stored in the data transfer scheme storing unit 103 at the data transfer scheme setting unit 102 as a transfer mode (step S231), cancels the transfer mode which is stored in the data transfer scheme storing unit 103 (step S232), and then performs a system operation processing (step S233). When the transfer mode before receiving resetting is stored in the data transfer scheme storing unit 103 in step S230, the reset judging unit 105 performs setting of the transfer mode which is stored at the data transfer scheme storing unit 103 (step S231), thereby the transfer mode becoming the same as that by the host PC 113, and thus the transfer mode is synchronized with the host PC 113. When the transfer mode is not stored in the data transfer scheme storing unit 103 (No at step 230), subsequently, a system operation processing is performed (step S233). Besides, no transfer mode is stored in the data transfer scheme storing unit 103 (No at step S230), the transfer mode is determined by the host PC 113 in the system operation processing (step S233).

As described, according to the present embodiment, the data transfer scheme is stored in the data transfer scheme storing unit 103, it is judged by the reset judging unit 105 on whether it is a reset due to reset pulses or not at the reset starting, and if it is a reset due to reset pulses, the stored data transfer scheme is employed to carry out a data communication. Therefore, even when resetting is performed by external disturbances such as static-electricity, there arises no significant load to the host PC, and thereby a stable data transfer or power saving can be realized.

### Embodiment 2

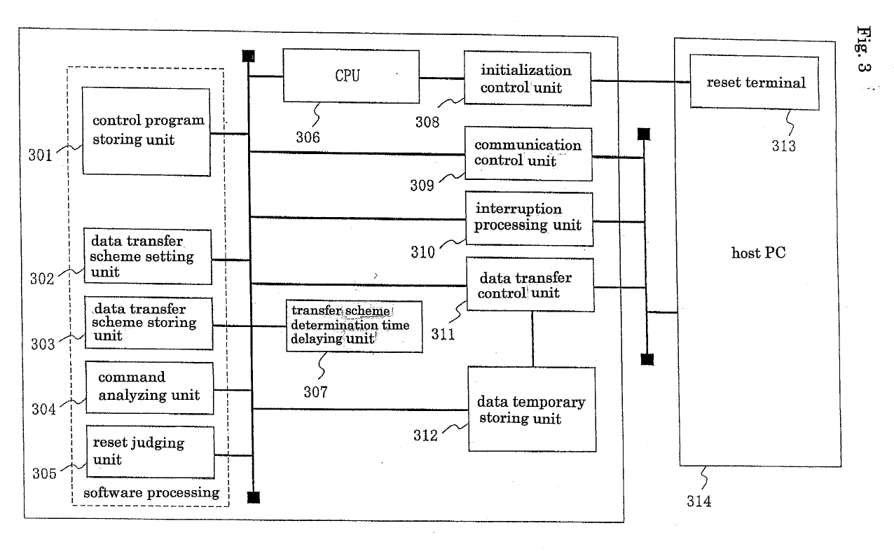

FIG. 3 is a block diagram illustrating a construction of an optical disk control device according to a second embodiment of the present invention. The optical disk control device of this second embodiment corresponds to the invention of claim 2. In this second embodiment, a transfer scheme determination time delaying unit 307 which inserts a delay of several m-seconds before determining the data transfer is added to the optical disk control device of the first embodiment. In FIG. 3, the numerals 301 to 306, and 308 to 314 are the same as 101 to 113 in FIG. 1.

In the optical disk control device of the first embodiment, if reset pluses are generated in plural times, when a default value is set as a transfer mode of an optical disk control device at initializations at second time and followings, there may occur in-coincidence in the transfer scheme between the host PC and the optical disk control device, resulting in a mismatch in the control of the data transfer, leading to a hung-up in the data communication. That is, in a case where, for example, two pulses are generated, if a second pulse is received before a new transfer mode designated by a command of the host PC is stored in the data transfer scheme memory unit 303 by a first pulse in step S209a in FIG. 2(a) by a first tome pulse, a processing again starts from an operation of issuing a reset signal to the CPU in step S203 with the transfer mode which was designated by the first pulse not being stored in the data transfer scheme storing unit 303, resulting in coincidence in the transfer scheme between the host PC and the optical disk control device.

In this second embodiment, with considering that the reset pulse time interval is several its, a waiting of a time interval that is larger than the reset pulse time interval, i.e., of several m-seconds is inserted before determining the transfer mode. Thereby, the second time pulse comes before performing a first time pulse processing, and therefore, it does not occur that a next pulse is issued during performing processing of storing the transfer mode that is designated by the first pulse processing into the data transfer scheme storing unit, thereby the transfer mode that is stored in the data transfer scheme storing unit of the optical disk control device can be set even at the initialization by the second time pulse and followings, and thus, the transfer scheme can be in coincidence between the host PC and the optical disk control device.

Hereinafter, the operation of the optical disk control device according to the second embodiment of the present invention will be described in detail.

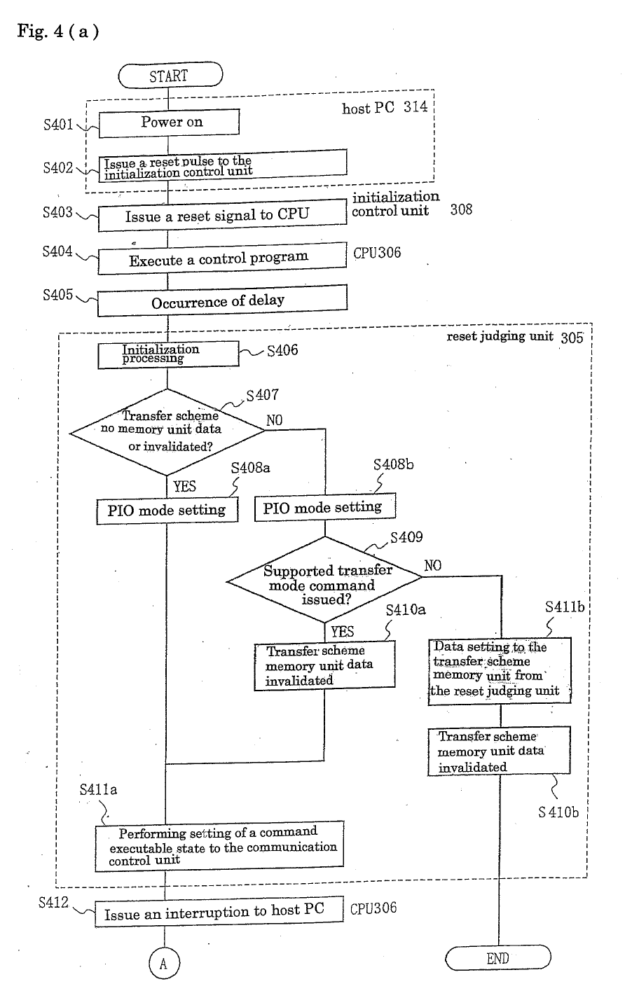

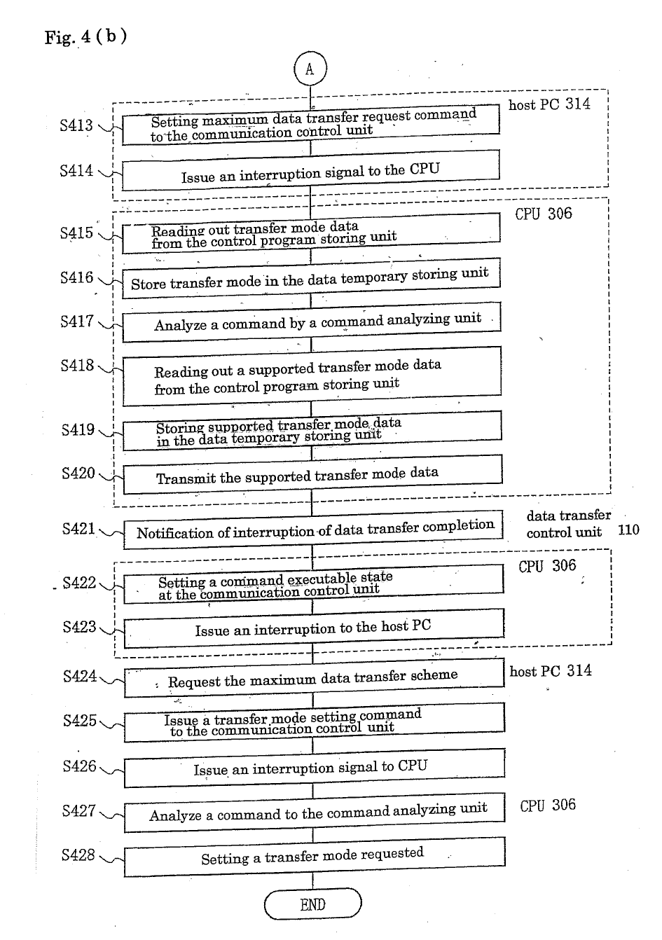

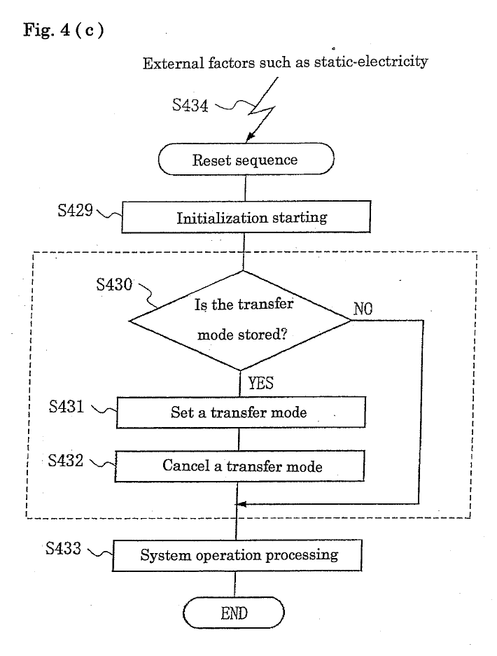

FIG. 4(a) to 4(c) are flowcharts illustrating the operation of the optical disk control device according to the second embodiment of the present invention.

First of all, the operation after powering-up of the host PC will be described.

In FIG. 4(a), after the powering-up of the host PC 314 (step S401), the host PC 314 issues a reset pulse from the reset terminal 313 to the initialization control unit 308 of the optical disk control device (step S402).

The initialization control unit 308 issues, after receiving the reset pulse, a reset signal to the CPU 306 (step S403).

After the reset request, the CPU 306 executes an optical disc control program stored in the control program storing unit 301 (step S404).

The transfer scheme determination time delaying unit 307 inserts a waiting of several m-seconds before determining the transfer mode. Thereby, a delay is generated up to determining the data transfer scheme (step S405).

The reset judging unit 305 performs, at initialization starting, respective initialization processing (step S406), and confirms that no data is present or invalidated data is set in the data transfer scheme storing unit 303 (step S407).

Here, since when the power is in ON state, no data is present or invalidated data is set in the data transfer scheme storing unit 303 (Yes in step S407), the PIO mode as a default value of the data transfer scheme is stored in the data transfer scheme setting unit 302 (step S408a). Thereby, the initial transfer mode after powering-up is determined to be PIO mode.

When an effective transfer mode is set in the data transfer scheme storing unit 303 (No at step S407), the PIO as a default value is once stored (step S408b). Then, a command of next host PC 314 is confirmed. When a command requesting a supported transfer mode is issued from the host PC 314 (Yes at step S409), the judging unit 305 judges that it is a powering-up and the reset pulse is a request from the host PC, and invalidates the data of the data transfer scheme storing unit 303 with remaining the setting of the default value (step S410a). Then, the transfer mode in the past in the data transfer scheme storing unit 303 is cancelled and a transfer mode designated by the command is stored. Thereby, the transfer mode is determined to the transfer mode which is designated by the command of the host PC 314.

Next, when the data transfer scheme is determined to be the PIO data at step S408a, or determined to the transfer mode that is designated by the command from the host PC 314 at step S410a, a setting which makes the communication control unit 309 in a state executable for a command from the host PC 314 (step S411a). After setting the communication control unit 309 at a state executable for a command from the host PC 314 (step S411a), the CPU 306 controls the interruption processing unit 310, thereby issuing an interruption signal to the host PC 314 (step S412).

The host PC 314 judges, by an interruption, that the optical disk control device is receivable for a command, and request the maximum data transfer scheme that is supported by the optical disk control device. As shown in FIG. 4(b), the host PC 314 sets a command requesting a transfer mode that is supported by the optical disk control device in the communication control unit 309 (step S413). When a command is set in the communication control unit 309, the host PC 314 controls the interruption processing unit 310 to issue an interruption signal to the CPU 306 (step S414). The CPU 306 reads out the transfer mode data from the control program storing unit 301 (step S415), and stores the transfer mode data in the data temporary storing unit 312 (step S416).

In addition, the CPU 306 which received the interruption signal analyzes the command which was set in the communication control unit 309 by the command analyzing unit 304 (step S417), and judges it as a command transmitting the supported transfer mode. The CPU 306 reads out the supported transfer mode data from the control program storing unit 301 (step S418), and stores it in the data temporary storing unit 312 (step S419).

The CPU 306 controls the data transfer scheme setting unit 302 to transmit the supported transfer mode data in the data temporary storing unit 312 to the host PC 314 (step S420). After the data transmission, the data transfer control unit 311 controls the interruption control unit 310 to issue an interruption signal informing the completion of the data transfer to the CPU 306 (step S421). The CPU 306 performs, after receiving the interruption signal, a setting making the communication control unit 309 in a state executable a command from the host CPU 314 (step S422).

After setting the communication control unit 309 in a state executable for a command from the host PC 314 (step S422), the CPU 306 controls the interruption processing unit 310 to issue an interruption signal to the host CPU 314 (step S423).

The host PC 314 requests a data transfer scheme by which the maximum transfer rate of the optical disk control device can be expected from the supported transfer mode data (step S424).

The host PC 314 issues a transfer mode setting command to the communication control unit 309 (step S425). When a command is set in the communication control unit 309, the host PC 314 controls the interruption processing unit 310 to issue an interruption signal to the CPU 306 (step S426). The CPU 306 which received the interruption signal analyzes the command which is set in the communication control unit 309 by the command analyzing unit 304 (step S427), and judges it as a command for setting a command. The CPU 306 sets the transfer mode that is requested in the data transfer scheme setting unit 302 (step S428). In this way, after the powering-up, setting of a transfer mode according to a usual operation is performed.

The reset control unit 305 stores, when the above-described transfer mode setting command is issued, the transfer mode which is set in the data transfer scheme setting unit 302 in the data transfer scheme storing unit 303.

Thereafter, the data communication is controlled in the set transfer mode.

Next, an operation when resetting is triggered by noises will be described. When reset pulses are noises, an operation from step S403 to step S410b shown in FIG. 4(a) is performed.

When the rest pulses which are inputted to the initialization control unit 308 are noises, no supported transfer mode command is issued. Accordingly, when no command requesting a supported transfer mode is issued from the host PC 314 (No at step S409), the reset judging unit 305 judges that the reset pulse is due to noises, and sets the transfer mode by which it is operated before receiving the resetting in the data transfer scheme storing unit 303 (step S411b), and further stores the data which is stored in the data transfer scheme storing unit 303 in the data transfer scheme setting unit 302. In addition, the reset judging unit 305 invalidates the data stored in the data transfer scheme storing unit 303 (step S410b), and stores the invalidated data in the data transfer scheme storing unit 303. Herein, in order to start driving as soon as possible at powering-up, setting of the invalidated data in the data transfer scheme storing unit 303 is performed.

In this way, when the reset pulse is due to noises, the data communication is controlled by the transfer mode which is set in the data transfer scheme setting unit 302, i.e., the transfer mode which is stored in the data transfer scheme storing unit 303.

Besides, the reset judging unit 305 cancels, when regions in the data transfer scheme storing unit 303 are gone to unable data storage, regions in the data transfer scheme storing unit 303 to secure regions.

Here, when the reset terminal picks up noises due to such as static-electricity and thereby the initialization control unit 308 erroneously judges a reset request, though the CPU 306 performs an initialization starting processing, the data transfer scheme is synchronized with the host PC 314, thereby occurring no hung-up. In addition, even when initialization execution processing in plural times are performed due to reset noises of several shots, a waiting time which is longer than the noise interval results a starting at a correct transfer mode.

For example, when there are, as shown in FIG. 4(c), external factors such as static-electricity (step S434), a reset sequence is started, and an initialization starting is performed by CPU 106 (step S429). Here, when there are external factors such as static-electricity, a delay generating operation entering a waiting is performed by the transfer scheme determination tine delaying unit 307 at the initialization starting (step S429).

When the transfer mode before receiving resetting is stored in the data transfer scheme storing unit 303 (Yes at step S403), the reset judging unit 305 sets the transfer mode which is stored in the data transfer scheme storing unit 303 into the data transfer scheme setting unit 302 as a transfer mode (step S431), cancels the transfer mode which is stored in the data transfer scheme storing unit 303 (step S432), and then a system operation processing (step S433) is performed. If the transfer mode before receiving resetting is stored in the data transfer scheme storing unit 303, the reset judging unit 305 sets the transfer mode which is stored in the data transfer scheme storing unit 303 (step S431) as a transfer mode, resulting in the same transfer mode as that of the host PC 314, and thereby the data transfer scheme is synchronized with the host PC 314. When no transfer mode is stored in the data transfer scheme storing unit 303 (No in step S430), subsequently a system operation processing is performed (step S433). Besides, when no transfer mode is stored in the data transfer scheme storing unit 303 (No at step S430), the transfer mode is determined by the host PC 314 in the system operation processing (step S433).

As described above, according to this embodiment, since there is provided a transfer scheme determination time delaying unit 307 which generates a time delay that is larger than the pulse generation interval before determining the data transfer, it is possible to carry out a data communication that is further stable even when a plurality of reset pulses are generated.

### Embodiment 3

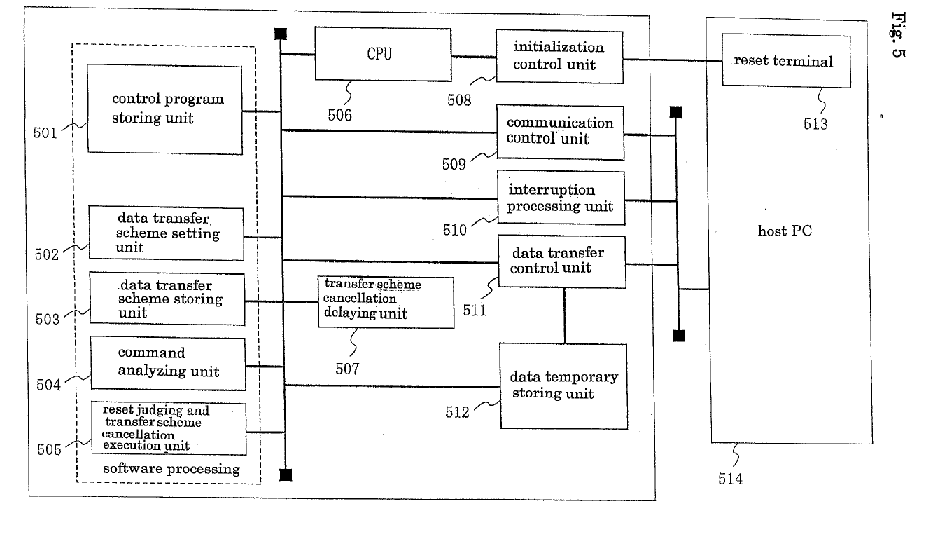

FIG. 5 is a block diagram illustrating a construction of an optical disk control device according to a third embodiment of the present invention. This third embodiment of the present invention corresponds to the invention of claim 3 of the present invention. This third embodiment includes a transfer scheme canceling delay unit 507 which issues a request signal for requesting cancellation of the transfer scheme one minute later to the reset judgment/transfer scheme cancellation execution unit 507 one minute later in order to realize the data transfer cancellation one minute later, in addition to the optical disk control device of the first embodiment. In addition, the reset judgment/transfer scheme cancellation execution unit 505 is configured to further make the reset judging unit 105 perform cancellation of the transfer scheme in addition to the reset judgment. Besides, reference numerals 501 to 514 shown in FIG. 5 are the same as reference numerals 101 to 104 and 106 to 113 shown in FIG. 1.

In the optical disk control device of the second embodiment, if reset pulses of longer pulse intervals are generated in plurality of times, when a default value is set as a transfer mode of the optical disk control device at initializations at second time and followings, there may occur in-coincidence in the transfer scheme between the host PC and the optical disk control device, resulting in a mismatch in the control of the data transfer, leading to a hung-up in the data communication. That is, when a reset pulse is generated immediately after, for example, a transfer mode is restored from the data transfer scheme storing unit and that new transfer mode is cancelled, the host PC would be hung-up since no new transfer mode is stored in the data transfer scheme storing unit as well as no transfer mode to which it is to be restored is set.

In this third embodiment, with considering that when reset pulses of longer intervals are generated, reset pulses may be generated after setting he transfer mode, it is configured to insert a waiting time so as to wait a cancellation processing for canceling the transfer mode stored on the data transfer scheme storing unit. Since a next reset pulse is generated during waiting the execution of processing, there arises no situation where there arise reset pulses immediately after the transfer mode is cancelled.

More concretely, while there usually arises an external disturbance due to the static-electricity at opening a tray becoming noises, with considering that the tray open-close interval is several tens second, inserting a waiting of a waiting time (for example, about one minute) that is larger than the time from the tray being opened to closed enables setting of the transfer mode which is stored in the data transfer scheme storing unit of the optical disk control device at the initializations at second time and followings, thereby avoiding the possibility of occurring the data communication hung-up.

Hereinafter, the operation of the optical disk control device of the third embodiment of the present invention will be described.

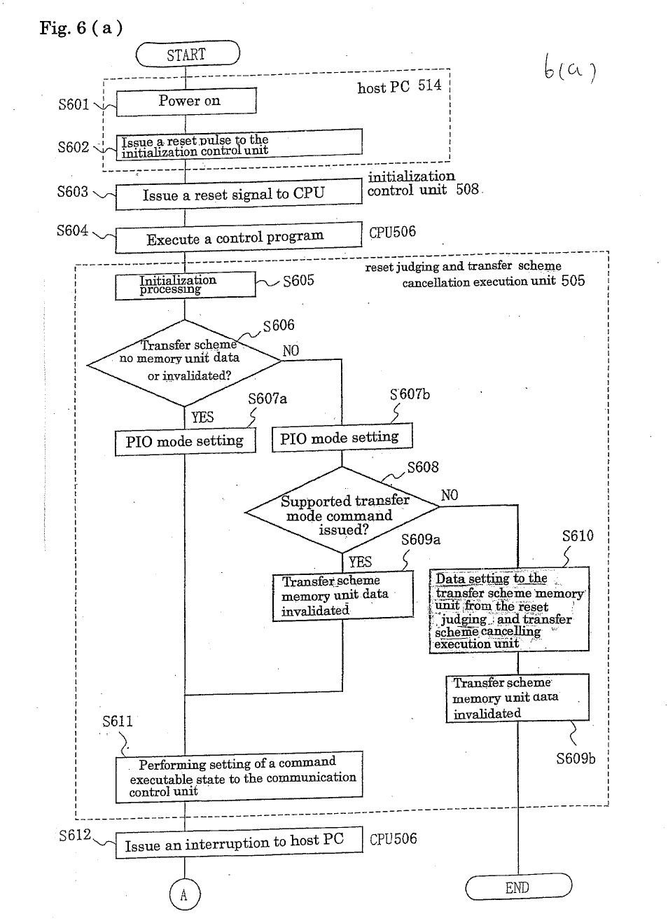

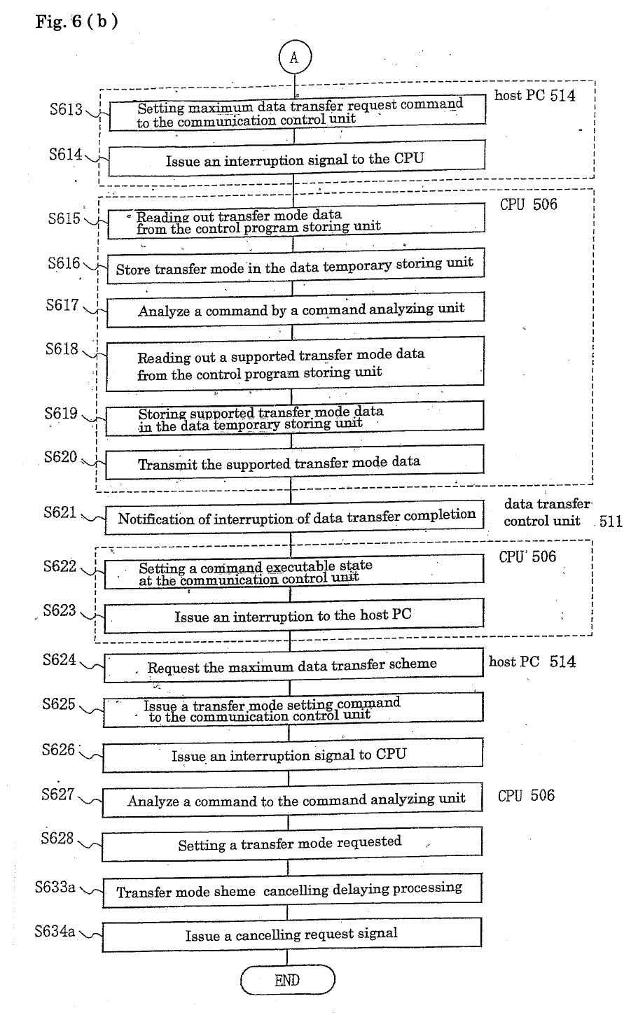

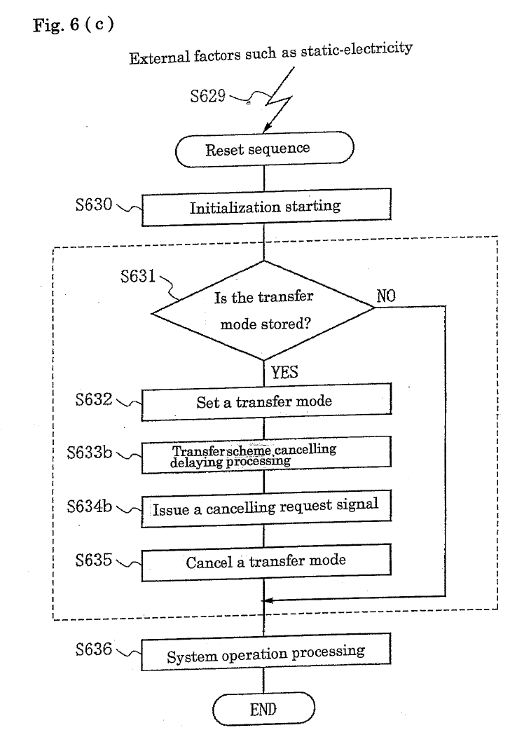

FIG. 6(a) to 6(c) are flowcharts illustrating the operation of the third embodiment of the present invention.

First of all, an operation after powering-up of the host PC will be described.

In FIG. 6(a), after the host PC 514 being powered-up (step S601), the PC 514 issues a rest pulse from the reset terminal 513 to the initialization control unit 508 of the optical disk control device (step S602).

The initialization control unit 508 issues, after receiving the reset pulse, a reset pulse to the CPU 506 (step S603).

After performing the reset request, the CPU 506 executes an optical disc control program which is stored in the control program storing unit 501 (step S604).

The reset judgment/transfer scheme cancellation execution unit 505 performs respective initialization processing at the initialization starting (step S605), and confirms that no data is present or invalidated data is set in the data transfer scheme storing unit 503 (step S606).

Here, since at turning on the power, no data is present or invalidated data is set in the data transfer scheme storing unit 503 (Yes at step S606), a PIO mode as a default value of the data transfer scheme is set in the data transfer scheme setting unit 502 (step S607a). Thereby, the initial transfer mode after the powering-on is determined to the PIO mode.

When a transfer mode that is effective to the data transfer scheme storing unit 503 is set in the data transfer scheme storing unit (No at step S606), the reset judgment and transfer scheme cancellation execution unit 505 once stores the PIO as a default value in the data transfer scheme setting unit 502 (step S607a). Then, it confirms a command from the next host PC 514 (step S608). When a command requesting the supported transfer mode is issued from the host PC 514 (Yes at step S608), the reset judging and transfer scheme cancellation execution unit 505 judges that it is a powering-up and the reset pulse is a request from the host PC 514, and while maintaining the setting of the default value as it is, invalidates the data of the data transfer scheme storing unit 503 (step S609a). Then, in step S609a, the transfer mode in the past in the data transfer scheme storing unit 503 is cancelled, and the transfer mode designated by the command is stored therein. Thereby, the transfer mode is determined to the transfer mode designated by the command from the host PC 514.

Next, when the data transfer scheme is determined to be the PIO data in step S607a, or to be the transfer mode designated by the command from the host PC 514 in step S609a, a setting making the communication control unit 509 executable for a command from the host PC 514 is performed (step S611). After setting the communication control unit 509 at an executable state for the command from the host PC 514, the CPU 506 controls the interruption processing unit 510 to issue an interrupt signal to the host PC 514 (step S612).

The host PC 514 judges by an interruption that the optical disk control device is in a command receivable state, and requests the maximum data transfer scheme which is supported by the optical disk control device. As shown in FIG. 6(b), the host PC 514 sets a request command requesting a transfer mode supported by the optical disk control device to the communication control unit 509 (step S613). When the command is set in the communication control device 509, the host PC 514 controls the interruption processing unit 510 to issue an interruption signal to the CPU 506 (step S614). The CPU 506 which received the interruption signal 506 analyzes the command which is set in the communication control unit 509 by the command analyzing unit 504, and judges it as a command transmitting the supported transfer mode. The CPU 506 reads out the transfer mode data from the control program storing unit 501 (step S615), and stores the transfer mode data in the data temporary storing unit 512 (step S616).

In addition, the CPU 56 which received the interrupt signal analyses the command by the command analyzing unit 504 (step S617), reads out the supported transfer mode data from the control program storing unit (step S618), and stores the supported transfer mode data in the data temporary storing unit 512 (step S619).

The CPU 506 controls the data transfer scheme setting unit 502 to transmit the supported transfer mode data in the data temporal storing unit 512 to the host PC 514 (step S620). After completing the data transmission, the data transfer control unit 511 controls the interruption processing unit 510 to issue an interruption signal informing the completion of data transfer to the CPU 506 (step S621). The CPU 506 performs, after receiving the interruption signal, a setting in the communication control unit 509 for making the communication control unit 509 in an executable state for a command from the host CPU 509 (step S622).

After setting the communication control unit 509 in an executable state for a command from the host PC 514 (step S622), the CPU 506 controls the interruption control unit 510 to issue an interrupt signal to the host PC 514 (step S623).

The host PC 514 issues a request requesting a data transfer scheme by which the maximum transfer rate of the optical disk control device can be expected among the supported transfer mode data (step S624).

The host PC 514 issues a transfer mode setting command to the communication control unit 509 (step S625). When the command is set in the communication control unit 509, the host PC 514 controls the interruption processing unit 510 to issue an interruption signal to the CPU 506 (step S626). The CPU 506 which received the interruption signal analyzes the command which is set in the communication control unit 509 by the command analyzing unit 504 (step S627), and judges it as a command for setting a transfer mode. The CPU 506 sets the transfer mode requested in the data transfer scheme setting unit 502 (step S628). In this way, after the powering-up, the setting of the transfer mode according to a usual operation is performed.

The reset judging/transfer scheme cancellation execution unit 505 stores, when the above-described transfer mode setting command is issued, the transfer mode which is set in the data transfer scheme setting unit 502 in the data transfer scheme storing unit 503.

After the transfer mode is determined, the transfer scheme cancellation delaying unit 507 performs a transfer scheme cancellation delaying processing by counting one minute (step S633a), and issues a request signal requesting a cancellation of the transfer mode to the reset judging/transfer scheme cancellation execution unit 505 in order to cancel the transfer mode stored in the data transfer scheme storing unit 503 (step S633b).

The reset judgment/transfer scheme cancellation execution unit 505 stores invalidated data in the data transfer scheme storing unit 503 in order to invalidate the data in the data transfer scheme storing unit 503.

The reset judgment/transfer scheme cancellation execution unit 505 cancels regions in the data transfer scheme storing unit 503 so as to secure regions when regions in the data transfer scheme storing unit 503 are gone, thereby to unable storage of data.

Thereafter, the data communication is controlled at the set transfer mode.

Next, an operation in a case where resetting is triggered by noises will be described. When the reset pulse is due to noises, an operation from step S603 to step S609b shown in FIG. 6(a) is performed.

When the reset pulse inputted to the initialization control unit 508 is due to noises, no supported transfer mode command is issued. Therefore, when no command requesting the supported transfer mode is issued from the host PC 514 (No at step S608), it is judged that the reset pulse is due to noises by the reset judging/transfer scheme cancellation execution unit 505, and the reset judging/transfer scheme cancellation execution unit 505 sets the data of transfer scheme under which it is operated before receiving the resetting in the data transfer scheme storing unit 503 (step S610), and further stores the data stored in the data transfer scheme storing unit 503 in the data transfer scheme setting unit 502. In addition, the reset judging/transfer scheme cancellation execution unit 505 invalidates the data stored in the data transfer scheme storing unit 503 (step S609b) and sets the invalidated data in the data transfer scheme storing unit 503. Here, in order to start driving as soon as possible at the powering-up, setting of the invalidated data in the data transfer scheme storing unit 503 is performed. Thus, at the initializations by noises, setting of the transfer mode at the resetting by noises is carried out.

In this way, when the reset pulse is due to noises, the data communication is controlled by the transfer mode which was set in the data transfer scheme setting unit 502, i.e., the transfer mode which was stored in the data transfer scheme storing unit 503.

Here, when the reset terminal picks up noises due to such as static-electricity and the initialization control unit 107 erroneously judges a reset request, though the CPU 506 performs an initialization starting processing, there arises no hung-up since due to the reset judgment/transfer system cancellation execution unit 505 the data transfer scheme is synchronized with the host PC 513. In addition, even in the initialization execution processing due to reset noises of long intervals performed in a plurality of times, the starting at a correct transfer mode is carried out.

For example, when there are, as shown in FIG. 6(c), external factors such as static-electricity (step S629), a reset sequence is started, and an initialization starting is performed (step S609). When the transfer mode before receiving the resetting is stored in the data transfer scheme storing unit 503 (Yes at step S606), the reset judgment/transfer scheme cancellation execution unit 505 stores the transfer mode which is stored in the data transfer scheme storing unit 503 in the transfer scheme setting unit 502 as a transfer mode (step S632), and the transfer scheme cancellation delaying unit 507 counts by one minute to perform a transfer scheme cancellation delaying processing (step S633b), issues a signal requesting a transfer scheme cancellation to the reset judgment/transfer scheme cancellation execution unit 505 (step S634b), and cancels the transfer mode which is stored in the data transfer scheme storing unit 503 (step S635), and performs a system operation processing (step S636). If the transfer mode before receiving the resetting is stored in the data transfer storing unit 503 in step S631, the reset judgment/transfer scheme cancellation execution unit 505 sets the transfer mode which is stored in the data transfer scheme storing unit 503 as a transfer mode (step S632), thereby providing the same transfer mode as that of the host PC 514, resulting in the data transfer scheme that is synchronized with the host PC 514. When no transfer mode is stored in the data transfer scheme storing unit 503 (No in step S606), subsequently a scheme operation processing is performed (step S636). Besides, when no transfer mode is stored in the data transfer scheme transfer storing unit 503 (No at step S631), the transfer mode is determined in the system operation processing by the host PC 514 (step S636).

As described above, according to the present embodiment, since it is configured such that the reset judging/transfer scheme cancellation unit 505 further performs, in addition to the reset judgment, a cancellation of the transfer scheme, and a transfer scheme cancellation delaying unit 507 which outputs a signal requesting cancellation of the transfer scheme after the tray is closed to the reset judging/transfer scheme cancellation unit 505 is further provided, the transfer mode can be set to one which is stored in the data transfer scheme storing unit of the optical disc control device even when reset pulses are generated in plural times, thereby a further stable data communication can be carried out.

### Embodiment 4

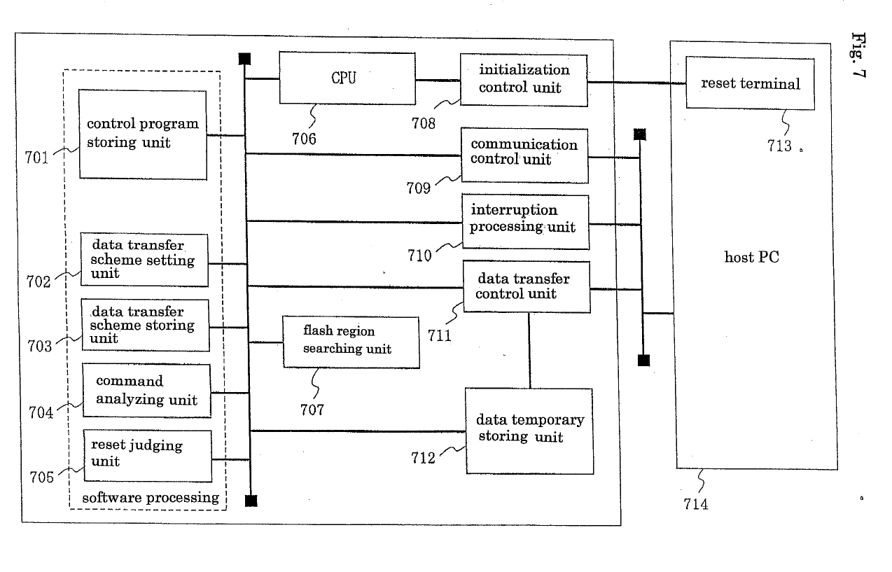

FIG. 7 is a block diagram illustrating a construction of an optical disk control device according to a fourth embodiment of the present invention. This fourth embodiment of the present invention corresponds to the invention recited in claim 4. This fourth embodiment includes, in addition to the optical disk control device of the first embodiment, a flash region searching unit 707 which searches vacant regions of other sectors before flash erasing, and changes the flash regions which are used by the data transfer scheme storing unit 703. The flash storing region searching unit 707 stores sector numbers which have been used, and when there is no vacant sector, cancels the sector numbers which are stored so as to secure regions. Besides, reference numerals 701 to 706, 708 to 714 are the sane as reference numerals 101 to 103 in FIG. 1.

In the optical disc control device of the first embodiment, memory regions of the data transfer scheme storage unit are fixed, and there may be a case where the transfer scheme cannot be stored correctly if there occurs rewriting into the same regions.

In this fourth embodiment, with considering that the storage of data such as a transfer scheme is carried out in a readable and writable memory unit such as a flash ROM, the rewriting is performed in a unit of several kilobytes called as a sector, the number of such rewriting is about ten thousands times, and further, regions handled by the data transfer scheme storing unit is about 64 bytes and the usual flash ROM used that is used by the optical disk control device has vacant regions of such degree in any sector, it is possible to change the region that is used by the transfer scheme storing unit to lengthen the lifetime of the flash ROM so as to correctly store the transfer scheme.

Hereinafter, an operation of the optical disc control device according to the fourth embodiment of the present invention will be described in detail.

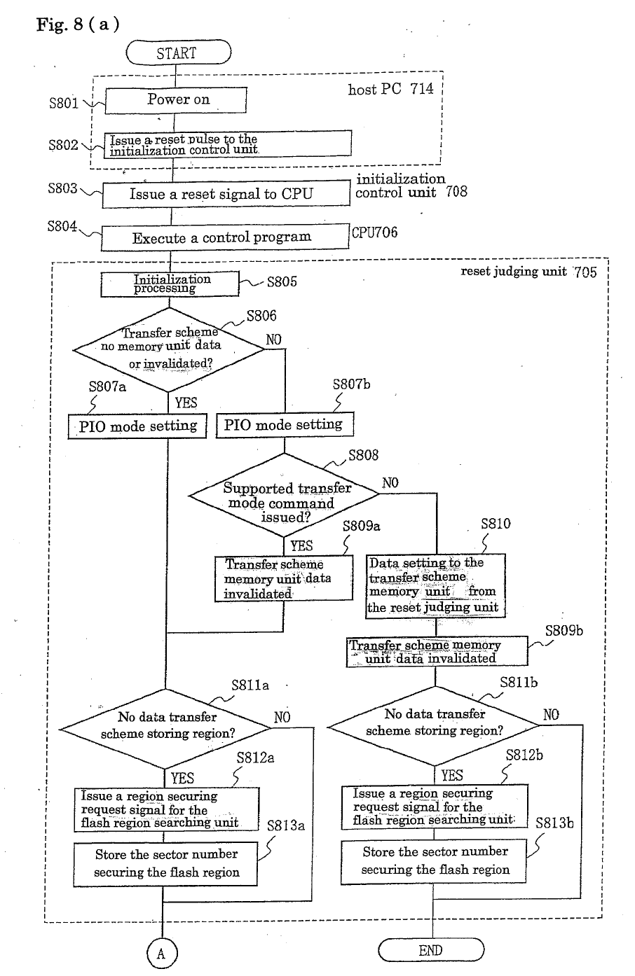

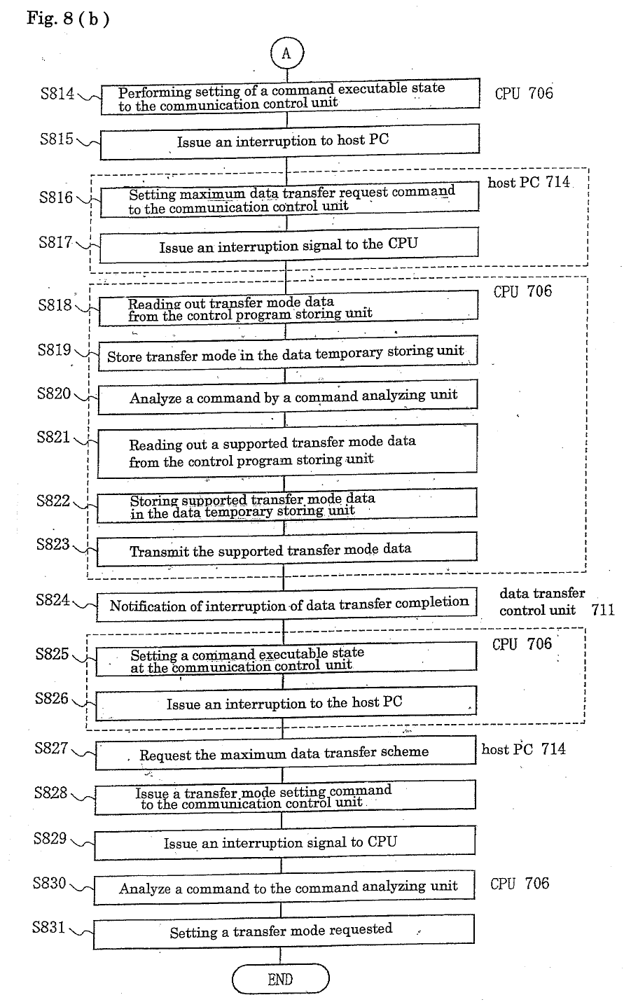

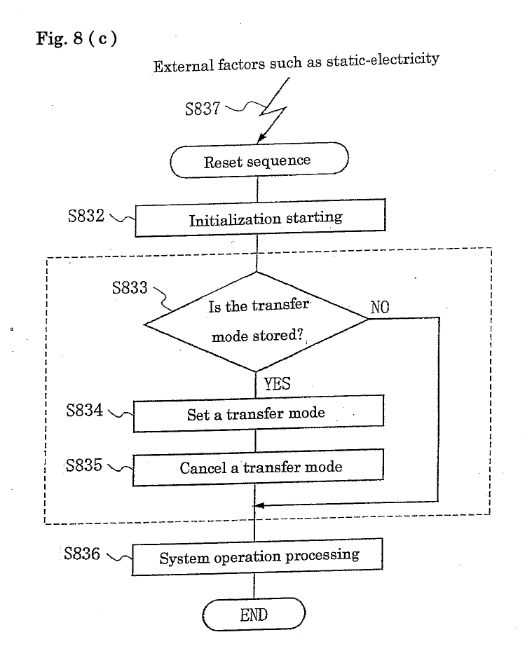

FIG. 8(a) to 8(c) are flowcharts illustrating an operation of an optical disk control device according to the fourth embodiment of the present invention.

First of all, an operation after the powering-up of the host PC will be described.

In FIG. 8(a), after powering-up the host PC 714 (step S801), the host PC 714 issues a reset pulse from the reset terminal 713 to the initialization control unit 708 of the optical disk control device (step S802).

The initialization control unit 708 issues, after having received the reset pulse, a reset signal to the CPU 706 (step S803).

After having issued the reset request, the CPU 706 executes an optical disc control program stored in the control program storing unit 701 (step S804).

The reset judging unit 705 performs respective initialization processing at initialization starting (step S805), and confirms that no data is present or invalidated data is set in the data transfer scheme storing unit 703 (step S806).

Here, since when the power is turned on, no data is present or invalidated data is set in the data transfer scheme storing pat 703 (Yes at step S806), the PIO mode as a default value of the data transfer scheme is stored in the data transfer scheme setting unit 702 (step S807a). Thereby, the initial transfer mode after the powering-on is determined to be PIO mode.

When an effective transfer mode is set in the data transfer scheme storing unit 703 (No at step S806), the PIO as a default value is once stored (step S807b). Then, the command from the host PC 714 is confirmed. When a command requesting the supported transfer mode is issued from the host PC 714 (Yes at step S808), the reset judging unit 705 judges that it is a powering-up and the reset pulse is a request from the host PC 714, and the reset judging unit 705 invalidates the data in the data transfer scheme storing unit 703 with maintaining the default value setting as it is (step S809a). Then, in step S809a, the transfer mode in the past in the data transfer scheme storing unit 703 is cancelled and the transfer mode designated by the command is stored. Thereby, the transfer mode is determined to the transfer mode which is designated by the command from the host PC 714.

The reset judging unit 705 issues, when regions in the data transfer scheme storing unit 703 are gone to unable storage of data (Yes at step S811a), a region securing request signal to the flash region searching unit 707 (step S812a). The flash region searching unit 707 searches vacant regions of other sectors, and if there is a sector which has a vacant region for storage of a data transfer scheme, it changes used regions in the data transfer scheme storing unit 703 to secure regions. Further, the flash region searching unit 707 stores sector numbers which are under use (step S813a). When there is no vacant region, the sectors which have been used are cancelled to secure regions.

Next, when the data transfer scheme is determined to be the PIO mode at step S807a, or determined to the transfer mode that is designated by the command from the host PC 714 at step S809a, a setting that makes the communication control unit 709 in an executable state for a command from the host PC 714 is performed as shown in FIG. 8(b) (at step S814). After setting the communication control unit 709 at an executable state for a command from the host PC 714 (step S814), the CPU 706 controls the interruption processing unit 710 to issue an interruption signal to the host PC 714 (step S815).

The host PC 714 judges, by an interruption, that the optical disk control device is in a receivable state for a command and request the maximum data transfer scheme that is supported by the optical disk control device. The host PC 714 sets a command requesting a transfer mode that is supported by the optical disk control device in the communication control unit 709 (step S816). When a command is set in the communication control unit 709, the host PC 714 controls the interruption processing unit 710 to issue an interruption signal to the CPU 706 (step S817). The CPU 706 reads out a transfer mode data from the control program storing unit 701 (step S818) and stores the transfer mode data in the data temporary storing unit 712 (step S819).

The CPU 706 which received the interruption signal analyzes the command which was set in the communication control unit 709 by the command analyzing unit 704 (step S820) and judges it as a command transmitting a supported transfer mode. The CPU 706 reads out the supported transfer mode data from the control program storing unit 701 (step S821) and stores it in the data temporary storing unit 712 (step S822).

The CPU 706 controls the data transfer scheme setting unit 702 to transmit the supported transfer mode data in the data temporary storing unit 712 to the host PC 714 (step S823). After completing the data transmission, the data transfer control unit 711 controls the interruption processing unit 710 to issue an interruption signal informing the completion of data transfer to the CPU 706 (step S824). The CPU 706 performs, after receiving the interruption, a setting that makes the communication control unit 709 in an executable state for a command from the host CPU 714 (step S825).

After the communication control unit 709 is set in an executable state for a command from the host PC 714 (step S825), the CPU 706 controls the interruption processing unit to issue an interruption signal to the host CPU 714 (step S826).

The host PC 714 requests a data transfer scheme by which the maximum transfer rate of the optical disk control device can be expected among the supported transfer mode data (step S827).

The host PC 714 issues a transfer mode setting command to the communication control unit 709 (step S828). When a command is set in the communication control unit 709, the host PC 714 controls the interruption processing unit 710 to issue an interruption signal to the CPU 706 (step S829). The CPU 706 which received the interruption signal analyzes the command which is set in the communication control unit 709 by the command analyzing unit 704 (step S830) and judges it as a command setting a transfer mode. The CPU 706 sets the transfer mode requested in the data transfer scheme setting unit 702 (step S831). In this way, after performing the powering-up, setting of a transfer mode according to a usual operation is carried out.

The reset judging unit 705 stores, when the above-described transfer mode setting command is issued, the transfer mode that is set in the data transfer scheme setting unit 702 in the data transfer scheme storing unit 703.

Thereafter, the data communication is controlled in the set transfer mode.

Next, an operation when resetting is triggered by noises will be described. When reset pulses are noises, an operation from step S803 to step S813b shown in FIG. 8(b) is performed.

When the rest pulses which are inputted to the initialization control unit 708 are noises, no command requesting the supported transfer mode is issued. Accordingly, when no command requesting a supported transfer mode is issued from the host PC 714 (No at step S808), the reset judging unit 705 judges that the reset pulse is due to noises and sets the transfer mode at which it is operated before receiving the resetting in the data transfer scheme storing unit 703 (step S810), and further stores the transfer mode which is stored in the data transfer scheme storing unit 703 in the data transfer scheme setting unit 702. In addition, the reset judging unit 705 invalidates the data stored in the data transfer scheme storing unit 703 (step S809b), and stores the invalidated data in the data transfer scheme storing unit 703. Herein, in order to start driving as soon as possible at the powering on, invalidated data is set in the data transfer scheme storing unit 703.

The reset judging unit 705 issues, when regions are gone in the data transfer scheme storing unit 703 to unable storage of data (Yes in step S811b), a region securing request signal to the flash region searching unit 707 (step S812b). The flash region searching unit 707 searches vacant regions of other sectors, and if there are sectors which have vacant regions which can be used for the data transfer scheme, it changes the regions used of the data transfer scheme storing unit 703 to secure regions. In addition, the flash region searching unit 707 stores the sector numbers which are under use (step S813b). If there is no vacant region, the sectors which have been used are cancelled to secure regions.

In this way, when the reset pulse is due to noises, the data communication is controlled by the transfer mode which is set in the data transfer scheme setting unit 702, i.e., the transfer mode which is stored in the data transfer scheme storing unit 703.

In addition, as shown in FIG. 8(c), when there are external factors such as static-electricity (step S837), a reset sequence is started, and an initialization starting is performed (step S832). When the transfer mode before receiving the resetting is stored in the data transfer scheme storing unit 703 (Yes at step S833), the reset judgment unit 705 stores the transfer mode stored in the data transfer scheme storing unit 703 in the transfer scheme setting unit 702 as a transfer mode (step S834) and cancels the transfer mode stored in the data transfer scheme setting unit 702 (step S835), and then performs a system operation processing (step S836). If the transfer mode before receiving the resetting is stored in the data transfer scheme storing unit 703, the reset judging unit 705 sets the transfer mode stored in the data transfer scheme storing unit 703 as a transfer mode (step S834), thereby providing the same transfer mode as that of the host PC 714, resulting in the data transfer state that is synchronized with the host PC 714. In addition, when the transfer mode is not stored in the data transfer scheme storing unit 703 (No at step S833), the transfer mode is determined by the host PC 113 in the system operation processing (step S836). In addition, when there are external factors such as static-electricity, an operation of securing a region in the data transfer scheme storing unit 703 is carried out by the flash region searching unit 707 during the system operation processing (at step S836).

As described above, according to this fourth embodiment, a flash storage region searching unit 707 is provided so as to search vacant regions of other sectors before the flash erasing, change flash regions used for the data transfer scheme storing unit 703, store the sector numbers which have been used, and cancel the sector numbers which have been stored thereby to secure regions when there are no vacant sectors. Therefore, the region that is used for the data transfer scheme storing unit 703 is changed so that no rewriting into the same region of the data transfer scheme storage unit 703 occurs, and thereby the lifetime of flash ROM for the data transfer scheme storing unit 703 is lengthened, being durable for a longer period of use.

### Embodiment 5

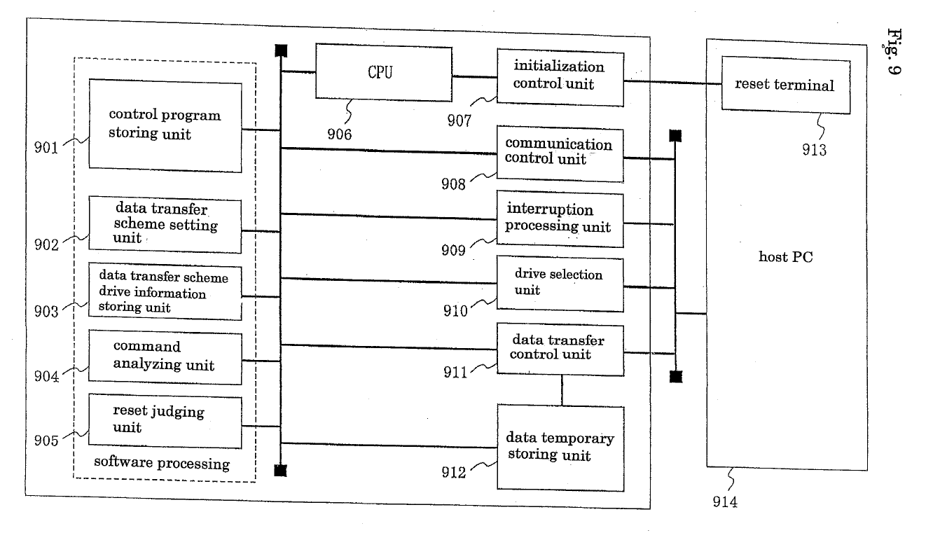

FIG. 9 is a block diagram illustrating a construction of an optical disk control device according to a fifth embodiment of the present invention. The optical disk control device of this fifth embodiment corresponds to the invention recited in claim 5.

In FIG. 9, reference numeral 910 designates a drive selection unit for determining whether the optical disk control device is a master or a slave. In addition, the drive selection unit 910 is omitted in the optical disk control device of the first embodiment shown in FIG. 1.

In addition, the data transfer scheme drive information storing unit 903 is provided by configuring the data transfer scheme storing unit 103 in the first embodiment to store, in addition to the transfer scheme, the drive information as to whether it is a master or a slave. Reference numerals 901, 902, 904 to 909 and 911 to 914 are the same as 101, 102, 104 to 113 in FIG. 1.

Next, a description is given of the operation of the optical disk control device according to the fifth embodiment of the present invention.

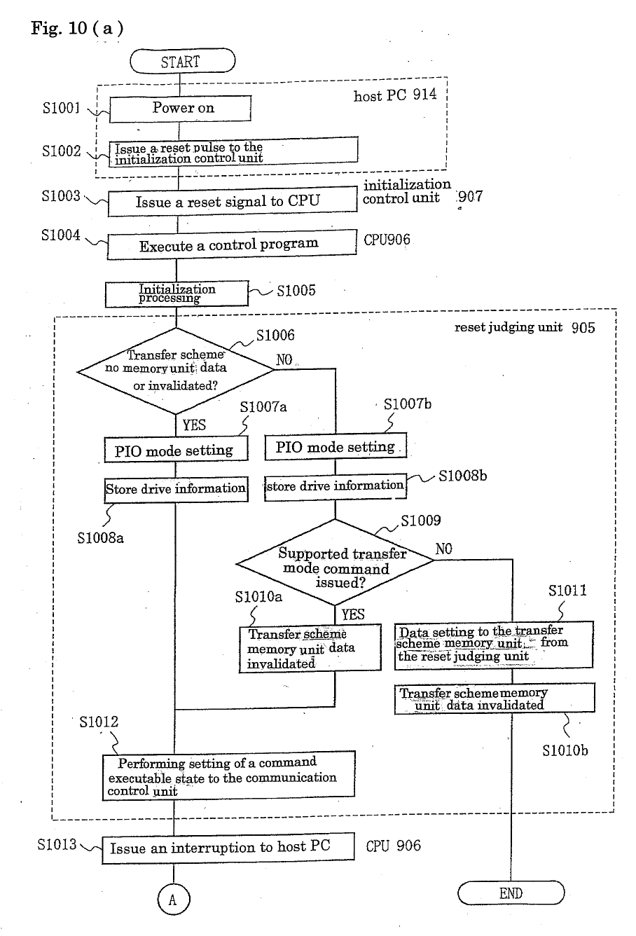

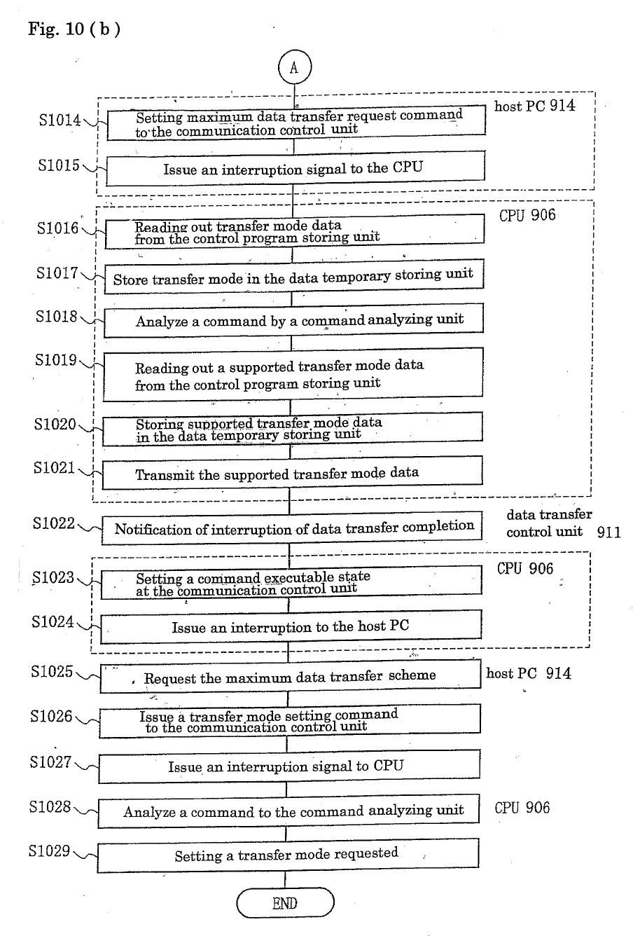

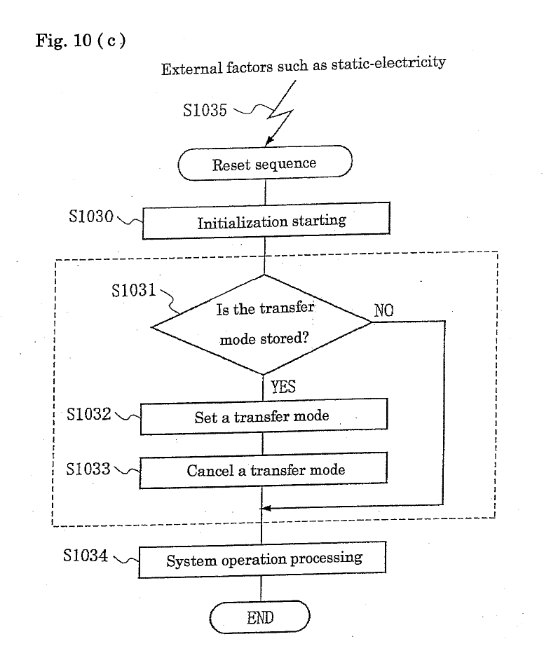

FIG. 10(a) to (c) are flowcharts illustrating the operation of an optical disk control device according to the fifth embodiment of the present invention.

The flowchart of this fifth embodiment shown in FIG. 10(a) is obtained by adding, at next to the steps S207a, S207b at which the PIO mode as a default value of the data transfer scheme is set in the data transfer scheme setting unit by the reset judging unit, the steps S1008a, S1008b for storing the drive information in the data transfer scheme drive information storing unit 903, respectively.

The operation of the optical disk control device according to this fifth embodiment is the same as that of the first embodiment except that not only the data transfer scheme but also the drive information are stored in the data transfer scheme drive information storing unit 903.

Here, in ATAPI which is a protocol at present for the transfer between the host PC and the optical disk control device, two pieces of devices can be connected via a cable. The devices are respectively set as a master and a slave, respectively, and the host PC selects a master drive or a slave drive when issuing a command.

The optical disk control device recognizes whether it is a master drive or a slave drive via an interchange through a signal line with the host PC thereby to store the drive information.

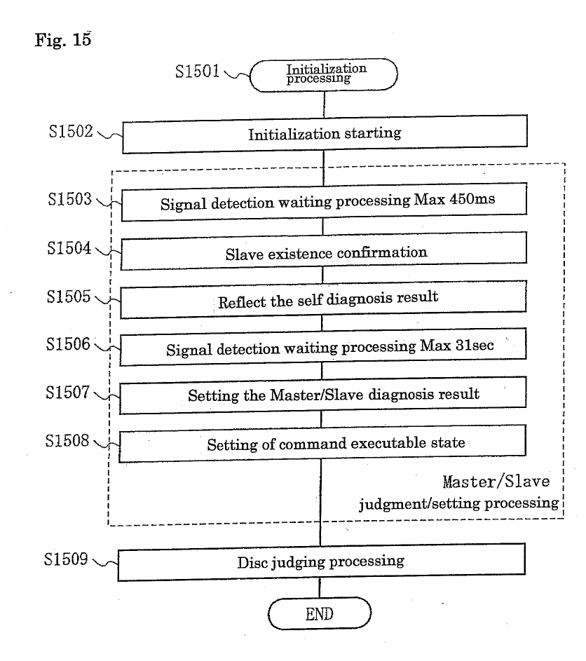

This judgment is surely accomplished at the initialization such as a hardware resetting. This processing generates a load to CPU when the resetting frequently occurs. The judgment processing which is carried out at the initialization as shown in FIG. 15 provides a load of above 30 s at maximum.

As shown in FIG. 15, an initialization processing is started (at step 1501), and an initialization starting is carried out (at step S1502). The optical disc control deice carries out a signal detection waiting processing (of Max 450 ms) with the host PC (at step S1503), and conforms the presence of Slave (at step S1504). The optical disk control device reflects the self diagnosis result as having confirmed the presence of Slave (at step S1505) to perform a signal detection waiting processing (of Max 31 sec) with the host PC (step S1506). The optical disk control device sets the master/slave diagnosis result (at step S1507) and sets itself in an executable state for a command from the host PC (at step S1508). Subsequently, a disc judgment processing is carried out (at step S1509).

This fifth embodiment stores not only the transfer mode as in the first embodiment but also the drive information to enable to perform restoration. Thereby, the Master/Slave processing as shown in FIG. 15 is gone, resulting in reduction in the CPU load.

As described above, according to this fifth embodiment, the data transfer scheme drive information storing unit 903 stores, in addition to the data transfer scheme, a drive information indicating being a master or a slave, and the optical disk control device is further provided with a drive selection unit 910 for determining whether the optical disc control device is a master or a slave. Therefore, no master/slave processing is required when performing initializations such as a hardware resetting, resulting in shortening of the optical disc starting time, as well as suppression of a load to CPU and enablement of power saving and high multiple speed in the data communication.

### APPLICABILITY IN INDUSTRY

The optical disk control device of the present invention is useful as one which can perform restoration of the system at a high speed without occurring a large load when a hardware resetting is performed from a reset terminal.

What is claimed is:

1. An optical disk control device, comprising:
a CPU for controlling an optical disk control device, connected to a host PC;
an initialization control unit for outputting an initialization request signal to the CPU when a reset pulse is issued from the CPU;
a control program storing unit for storing an optical disc control program;
a communication control unit for controlling issuance of a control command for controlling an optical disk control device and communication of information indicating a transfer enable state, a transfer state, and presence or non-presence of error generation with the host PC;
a data transfer scheme setting unit for storing a data transfer scheme;
a data transfer scheme storing unit for storing the data transfer scheme when the data transfer scheme is set from the host PC;
a data transfer control unit for receiving the data transfer request from the host PC and controlling the data transfer according to the transfer mode which is set at the data transfer scheme setting unit;
a data temporary storing unit for storing data via a bus;
an interruption processing unit for issuing an interruption signal to the CPU when reception of the data transfer control request and a communication control request are generated;
a command analyzing unit for analyzing the content of the optical disk control device control command and executing same; and
a reset judging unit for judging whether an initialization request signal is due to noises or a request from the host PC on the basis of presence or non-presence of the transfer mode setting from the host PC at an initialization starting, and judges whether the data transfer scheme is to be read out from the data transfer scheme storing unit to be set.

2. An optical disk control device as defined in claim 1, comprising a transfer scheme decision delaying unit which generates a time delay that is larger than a pulse generation interval before determining the data transfer scheme.

3. An optical disk control device as defined in claim 1, wherein
the reset judging unit further performs a cancellation of the transfer scheme, and
a transfer scheme cancellation delaying unit which outputs a transfer scheme cancellation signal to the reset judging unit after a tray is closed.

4. An optical disk control device as defined in claim 1, wherein
there is provided a flash storing region searching unit which, before performing flash erasing, searches vacant regions of other sectors to change the flash region to be used by the data transfer scheme storing unit, stores the sector numbers which have been used, and cancels, when there is no vacant sectors, the sector numbers which are stored to secure regions.

5. An optical disc storing device as defined in claim 1, wherein
the data transfer scheme storing unit is provided with a drive selection unit which further stores the drive information indicating a master or a slave, and determines whether the optical disk control device is a master or a slave.
